(19) United States
(12) Patent Application Publication
(10) Pub. No.: US 2023/0037034 A1
(43) Pub. Date: Feb. 2, 2023

(54) Graph-Based Recommendations

(71) Applicant: Optum, Inc., Minnetonka, MN (US)

(72) Inventors: Debraj Bhattacharya, Minnetonka, MN (US); Sharat Kumar H, Bangalore (IN); Manik Arora, Delhi (IN); Naresh Sugavanam, Cary, NC (US); Nitesh Verma, Uttar Pradesh (IN)

(21) Appl. No.: 17/389,341

(22) Filed: Jul. 30, 2021

(51) Int. Cl. G06N 5/04; G06F 16/901

(52) U.S. Cl. CPC G06N 5/04; G06F 16/9024

(57) ABSTRACT

Various embodiments of the present disclosure provide methods, apparatus, systems, computing entities, and/or the like, for providing a recommendation of a decision for an input case. According to some aspects, a method is provided. The method generally comprises receiving an input case data object; generating an input feature data object based at least in part on input case features of the input case data object; selecting a subgraph-based data structure from a graph-based data structure, the subgraph-based data structure identifying a subset of historical case data objects; generating a feature data model based at least in part on traversing the subgraph-based data structure; selecting a historical case cohort based at least in part on comparing the feature data model with the input feature data object; and providing a recommendation data object based at least in part on the historical case cohort.

### BACKGROUND

Various embodiments of the present disclosure address technical challenges related to providing a recommendation of a decision for an input case, such as a prior authorization case. Various embodiments further address the efficiency, reliability, and subjectivity shortcomings of existing decision-making and decision-recommending solutions.

### BRIEF SUMMARY

In general, embodiments of the present disclosure provide methods, apparatus, systems, computing devices, computing entities, and/or the like for providing a decision recommendation. Certain embodiments of the present disclosure utilize systems, methods, and computer program products that generate and provide a decision recommendation for an input case (e.g., a prior authorization case) by traversing a graph-based data structure and analyzing a historical case cohort. In various embodiments, a recommendation is generated based at least in part on decisions made in historical cases identified by the historical case cohort. In various embodiments, a subgraph-based data structure and a recommendation are dynamically selected and generated responsive to and based at least in part on each received input case. That is, various embodiments of the present disclosure are configured to dynamically generate and provide decision recommendations for each of a plurality of input cases.

In accordance with one aspect, a method is provided. In one embodiment, the method includes receiving an input case data object including one or more input case features describing the input case and generating an input feature data object based at least in part on the one or more input case features. The method further includes selecting a subgraph-based data structure from a graph-based data structure associated with a plurality of historical case data objects. The subgraph-based data structure identifies a subset of historical case data objects of the plurality of historical case data objects. Each historical case data object is associated with a historical point in time prior to a point in time associated with the input case data object. Each historical case data object includes a plurality of historical case features including a decision case feature. Further, each historical case data object comprises a first historical case feature substantially the same as a first input case feature in a first case feature dimension and a second historical case feature substantially the same as a second input case feature in a second case feature dimension.

The method further includes generating a feature data object based at least in part on performing one or more graph traversal operations on the subgraph-based data structure. The method further includes, for each of the subset of historical case data objects, generating a historical feature data object including one or more historical case features of the corresponding historical case data object based at least in part on the feature data model. The method further includes selecting a historical case cohort identifying one or more historical case data objects of the subset of historical case data objects based at least in part on comparing each historical feature data object to the input feature data object, and generating a recommendation data object for the input case data object based at least in part on the historical case cohort.

In accordance with another aspect, a computer program product is provided. The computer program product may include at least one computer-readable storage medium having computer-readable program code portions stored therein, the computer-readable program code portions including executable portions configured to cause at least one processor to at least receive an input case data object including one or more input case features describing the input case and to generate an input feature data object based at least in part on the one or more input case features. The computer-readable program code portions further include executable portions configured to cause at least one processor to select a subgraph-based data structure from a graph-based data structure associated with a plurality of historical case data objects. The subgraph-based data structure identifies a subset of historical case data objects of the plurality of historical case data objects. Each historical case data object is associated with a historical point in time prior to a point in time associated with the input case data object. Each historical case data object includes a plurality of historical case features including a decision case feature. Further, each historical case data object includes a first historical case feature substantially the same as a first input case feature in a first case feature dimension and a second historical case feature substantially the same as a second input case feature in a second case feature dimension.

The computer-readable program code portions further include executable portions configured to cause at least one processor to generate a feature data model based at least in part on performing one or more graph traversal operations on the subgraph-based data structure. The computer-readable program code portions further include executable portions configured to cause at least one processor to, for each of the subset of historical case data objects, generate a historical feature data object comprising one or more historical case features of the corresponding historical case data object based at least in part on the feature data model. The computer-readable program code portions further include executable portions configured to cause at least one processor to select a historical case cohort identifying one or more historical case data objects of the subset of historical case data objects based at least in part on comparing each historical feature data object to the input feature data object, and to generate a recommendation data object for the input case data object based at least in part on the historical case cohort.

In accordance with yet another aspect, an apparatus including at least one processor and at least one memory including computer program code is provided. In one embodiment, the at least one memory and the computer program code may be configured to, with the at least one processor, cause the apparatus to receive an input case data object including one or more input case features describing the input case and to generate an input feature data object based at least in part on the one or more input case features. The at least one memory and the computer program code may be further configured to cause the apparatus to select a subgraph-based data structure from a graph-based data structure associated with a plurality of historical case data objects. The subgraph-based data structure identifies a subset of historical case data objects of the plurality of historical case data objects. Each historical case data object is associated with a historical point in time prior to a point in time associated with the input case data object, and includes a plurality of historical case features including a decision case feature. Each historical case data object comprises a first historical case feature substantially the same as a first input case feature in a first case feature dimension and a second historical case feature substantially the same as a second input case feature in a second case feature dimension.

The at least one memory and the computer program code may be further configured to cause the apparatus to generate a feature data model based at least in part on performing one or more graph traversal operations on the subgraph-based data structure. The at least one memory and the computer program code may be further configured to cause the apparatus to, for each of the subset of historical case data objects, generate a historical feature data object comprising one or more historical case features of the corresponding historical case data object based at least in part on the feature data model. The at least one memory and the computer program code may be further configured to cause the apparatus to select a historical case cohort identifying one or more historical case data objects of the subset of historical case data objects based at least in part on comparing each historical feature data object to the input feature data object, and to generate a recommendation data object for the input case data object based at least in part on the historical case cohort.

### BRIEF DESCRIPTION OF THE DRAWINGS

Having thus described embodiments of the present disclosure in general terms, reference will now be made to the accompanying drawings, which are not necessarily drawn to scale, and wherein:

FIG. 1 provides an exemplary overview of a system that may be used to practice embodiments of the present disclosure.

FIG. 2A provides a diagram of an example system computing entity, in accordance with some embodiments discussed herein.

FIG. 2B provides a diagram of an example client computing entity, in accordance with some embodiments discussed herein.

FIG. 3 provides a flowchart diagram of an example process for providing a decision recommendation for an input case, in accordance with some embodiments discussed herein.

FIG. 4 provides a diagrammed overview of an example process for providing a decision recommendation for an input case, in accordance with some embodiments discussed herein.

FIG. 5 provides a flowchart diagram of an example process for generating a graph-based data structure for providing a decision recommendation for an input case, in accordance with some embodiments discussed herein.

FIG. 6 provides an example graph-based data structure for providing a decision recommendation for an input case, in accordance with some embodiments discussed herein.

FIG. 7 provides a flowchart diagram of an example process for comparing an input case with a historical case for providing a decision recommendation for the input case, in accordance with some embodiments discussed herein.

FIG. 8 provides a flowchart diagram of an example process for generating a decision recommendation for an input case, in accordance with some embodiments discussed herein.

FIG. 9 provides a flowchart diagram of an example process for generating a decision recommendation for an input case, in accordance with some embodiments discussed herein.

### DETAILED DESCRIPTION

Various embodiments of the present disclosure now will be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present disclosure are described with reference to providing decision recommendations, one of ordinary skill in the art will recognize that the disclosed concepts can be used in other decision-making applications.

### I. Overview and Technical Improvements

Various embodiments of the present disclosure address technical challenges related to recommending a decision for an input case. Various embodiments that provide a decision recommendation may be applied to cases, such as prior authorization cases which require at least an approval decision or a denial decision. Existing methods of determining a decision for cases such as prior authorization cases require manual human analysis of case details, features, and data. Such manual methods require large amounts of time and resources, and may be influenced by subjectivity or incomplete analysis of all relevant information. For example, current systems for decision-making in prior authorization cases take around 1 to 5 days. Furthermore, existing methods may be limited to examining and analyzing only case features in the case of interest, thereby potentially leading to inconsistencies in decisions across time. In contrast, various embodiments of the present disclosure provide automated methods and operations for generating and providing a decision recommendation, or a decision, using both case features in the case of interest and case features extracted from a historical case cohort. For example, various embodiments of the present disclosure generate and provide at least a decision recommendation in the span of 10 seconds.

Furthermore, various embodiments dynamically generate and provide a decision recommendation unique to an input case. For instance, various embodiments may be provided or may receive data relating to an input case, and generally may then dynamically select a subgraph-based data structure based at least in part on input case features of the input case. In various embodiments, various processes, steps, and operations are then performed to generate a decision recommendation for the input case using the subgraph-based data structure. Thus, the generated and provided decision recommendations in various embodiments are dynamic and responsive to each input case in a plurality of input cases. Various embodiments of the present disclosure may implement or be implemented as an Application Programming Interface (API), where an API response comprising a decision recommendation is provided in real-time and in response to an API call with data relating to an input case.

Specifically, various embodiments provided herein generate and provide a decision recommendation based at least in part on a historical case cohort. The historical case cohort identifies historical cases that are similar to the input case for which a decision is required. For instance, the historical cases of the historical case cohort may be selected from historical cases that include the same diagnosis code and procedure code as the input case based at least in part on a quantitative comparison between each historical case and the input case. The input case may involve a request for authorization of a procedure identified by the procedure code of the input case as well as a diagnosis identified by a diagnosis code, and the identified historical cases may have involved the same procedure identified by the same procedure code as well as the same diagnosis identified by the same diagnosis code, for example. In many instances, the procedure identified by the procedure code and for which authorization is requested is related or based at least in part on the diagnosis identified by the diagnosis code (e.g., treats, manages, cures, and/or the like the medication condition described in the diagnosis). The decision recommendation is then generated and provided based at least in part on historical decisions made in the historical cases. This provides the technical advantage of automated, consistent, and self-learning decision recommendations. By basing the decision recommendation for the input case on historical decisions, subjectivity and inconsistencies over time may be eliminated or reduced. Furthermore, decision recommendations for subsequent input cases may be generated and provided based at least in part on previous decision recommendations—or previous decisions based at least in part on previous decision recommendations—for previous input cases, for example, in instances where the previous input cases are similar (e.g., include the same diagnosis and procedure code) to the subsequent input cases.

Thus, various embodiments provide self-learning decision recommendations that are advantageous over rule-based decision recommendations. Existing methods that provide rule-based decision recommendations require large amounts of time and resources for evaluating each rule. For example, existing methods may have thousands of rules and conditions to evaluate. Addition of more rules thereby increases the amount of time and resources spent generating and providing a decision recommendation, in existing methods. On the other hand, various embodiments are more scalable and do not require or evaluate a large set of rules or conditions. It may be further appreciated that various embodiments of the present disclosure may embed such rules and conditions by including historical cases that were previously evaluating using rule-based systems. As such, various embodiments of the present disclosure may learn from existing methods and systems.

Furthermore, various embodiments of the present disclosure leverage graphical representations of cases, case features, and graph-based data structures. As described herein, a graph-based data structure may be used to store case features of a plurality of historical case data objects corresponding to a plurality of historical cases, and a subgraph-based data structure may be selected from the graph-based data structure to identify a subset of the historical cases. Further, the subgraph-based data structure may be traversed (e.g., via graph traversal operations) to collect information related to the subset of historical cases. Each node comprises case features of a specific case feature dimension, and nodes are connected with edges, thereby enabling traversal of the graph-based data structure and/or the subgraph-based data structure. For example, a historical feature data object corresponding to a historical case is generated by traversing the subgraph-based data structure and extracting, collecting, retrieving, and/or the like, relevant features from various traversed nodes. In fact, a plurality of historical feature data objects may be generated at substantially the same time and/or in an efficient manner, due to each node corresponding to one case feature dimension and storing case features of the corresponding case feature dimension of the plurality of historical cases. Thus, implementation and use of graph-based data structures and subgraph-based data structures provides technical advantages by improving processing and computing efficiency over existing methods, as a plurality of historical feature data objects may be generated in a rapid and parallel manner due to the interconnection of data in a graph-based data structure and a subgraph-based data structure.

Various embodiments provide a recommendation of a decision for an input case that includes additional information configured to provide context in association with the recommended decision. For example, various embodiments generate and provide a consequence prediction data object. The consequence prediction data object, for example, may be and/or may comprise an average cost of step therapy in denied historical prior authorization cases. As such, a user tasked with making a decision for an input case is provided with a recommended decision as well as additional information, such as predicted outcomes.

An exemplary application of various embodiments of the present disclosure relate to receiving an input case data object comprising one or more input case features describing an input case, generating an input feature data object based at least in part on the one or more input case features, selecting a subgraph-based data structure from a graph-based data structure to identify a subset of historical case data objects of a plurality of historical case data objects, generating a feature data model based at least in part on performing one or more graph traversal operations on the subgraph-based data structure, generating a plurality of historical feature data objects based at least in part on the feature data model, selecting a historical case cohort based at least in part on comparing each historical feature data object to the input case data object, and generating a recommendation data object based at least in part on the selected historical case cohort.

### II. Definitions

The term “input case data object” may refer to a data entity configured to describe an input case, such as a prior authorization case, a pre-authorization case, or generally a case for which a decision must be made. In various embodiments, an input case data object describes an input prior authorization case, for which a decision is required and requested, and specifically comprises case features describing aspects or dimensions of the input prior authorization case. For example, an input case data object comprises one or more case features describing a diagnosis of the medical condition of a patient related to the input prior authorization case, one or more case features describing procedures to be performed (e.g., by a healthcare provider) on the patient or procedures requested to be performed (e.g., in a prior authorization case) on the patient, one or more case features describing the patient (e.g., demographic data of the patient), one or more case features describing a healthcare provider for the patient (e.g., provider specialty, provider service setting) and/or other case features describing various dimensions of the input prior authorization case. As such, an input case data object comprises case features that may be numerical values, categorical values, and/or the like. For example, an input case data object comprises case features that may be and/or may comprise International Classification of Diseases (ICD) codes (e.g., ICD-9-CM codes, ICD-10-CM codes), Current Procedural Terminology (CPT) codes, Healthcare Common Procedure Coding System (HCPCS) codes, provider identifiers, patient coverage plan identifiers, and/or the like. An input case data object may be configured in various structures, forms, conformations, and/or the like. In various embodiments, an input case data object may be and/or may be configured as a n-order tensor (where n is any integer), list, data structure, vector, array, and/or the like, configured to contain or store one or more case features. For example, an input case data object is a vector of length L configured to contain or store L number of case features. Case features contained and stored in an input case data object that describe an input case are specifically referred to herein as input case features.

The term “input feature data object” may refer to a data entity configured to describe one or more input case features of an input case data object. For example, an input feature data object comprises one or more input case features of an input case data object. In various embodiments, an input feature data object is configured to describe a specific (e.g., selected, predetermined, learned) set or combination of input case features. An input feature data object may be any data structure, embedding, dataset, and/or the like, configured to describe one or more input case features of an input case data object. For example, an input feature data object comprises one or more embeddings or weights corresponding to one or more input case features of an input case data object. As another example, the input feature data object is a first-order tensor or vector containing one or more specific input case features. As another example, the input feature data object is a vector comprising one or more reduced dimension input case features, one or more embeddings or weights of a combination of input case features, and/or the like

The term “historical case data object” may refer to a data entity configured to describe a historical case, such as a prior authorization case, a pre-authorization case, or generally a case for which a decision has been made. The historical case described by a historical case data object may differ from an input case described by an input case data object by being associated with a historical point in time prior to a point in time associated with the input case. Furthermore, the historical case data object comprises a decision case feature describing a historical decision made in the historical case, while an input case data object does not comprise a decision case feature, as a decision has not been made in the input case. In various embodiments, a historical case data object describes a historical prior authorization case. Similar to an input case data object, a historical case data object comprises one or more case features describing aspects or dimensions of a corresponding historical prior authorization case. As previously described, case features may be and/or may comprise ICD codes, CPT codes, HCPCS codes, provider identifiers, patient coverage plan identifiers, and/or other data values or data objects configured to describe various dimensions of a corresponding historical prior authorization case. Likewise similar to an input case data object, a historical case data object may be and/or may be configured as a n-order tensor (where n ins any integer), list, data structure, vector, array, and/or the like, configured to store one or more case features. For example, a historical case data object is a vector of length L configured to contain or store L number of case features. Case features contained and stored in a historical case data object that describe a historical case are specifically referred to herein as historical case features.

The term “historical feature data object” may refer to a data entity configured to describe one or more historical case features of a historical case data object. For example, a historical feature data object comprises one or more historical case features of a historical case data object. In various embodiments, a historical feature data object is configured to describe a specific (e.g., selected, predetermined, learned) set or combination of historical case features. In various embodiments, a historical feature data object is configured to describe the same set or same dimensions of case features as an input feature data object. As a non-limiting example, an input feature data object is configured to contain an input case feature describing an age of a patient of an input case, and a historical feature data object is then likewise configured to contain a historical case feature describing an age of a patient of a historical case. In various embodiments, a historical feature data object may be any data structure, embedding, dataset, and/or the like. For example, a historical feature data object is a vector containing one or more specific historical case features. A historical feature data object correspond to one historical case data object and does not describe historical case features of other historical case data objects.

The term “case feature dimension” may refer to an aspect, dimension, component, and/or the like, of one or more cases, such as prior authorization cases, described by one or more case features. Prior authorization cases in general involve a patient and a healthcare provider, thus a case feature dimension describing a patient or a healthcare provider may span across all or most prior authorization cases. For example, a case feature dimension of patient age corresponds to case features (e.g., input case features, historical case features) describing patient ages for corresponding cases (e.g., input cases, historical cases). As another example, historical prior authorization cases include a historical decision, and as such, historical case features aligned with a historical decision dimension spanning the historical prior authorization cases may describe the historical decisions made in the corresponding historical prior authorization cases. In various embodiments, input case data objects and historical case data objects index case feature dimensions in the same configuration. For example, an input case data object and a historical case data object are both L-length vectors, and both vectors contain case features aligned with a patient gender dimension at a first index. That is, an L-length input case vector contains an input case feature describing the gender of a patient of an input case at a first index, and an L-length historical case vector contains a historical case feature describing the gender of a patient of a historical case at the same first index. In various embodiments, input feature data objects and historical feature data objects likewise index case feature dimensions in the same configuration.

The term “decision case feature” may refer to a data entity configured to describe a decision made in a case, such as a prior authorization case. Understood otherwise, a decision case feature may be a case feature configured to describe a decision dimension of a case. Specifically, decision case features are related to and describe historical cases, and therefore, decision case features are described, contained, stored, and/or the like by historical case data objects and historical feature data objects. Decision case features may be at least positive decision case features or negative decision case features. Positive decision case features may describe a positive decision made in a historical case, such as an approval of a prior authorization case. Meanwhile, negative decision case features may describe a negative decision made in a historical case, such as a denial of a prior authorization case. It will be understood that decision case features are not limited to positive and negative decision case features, and may be configured in any way to describe a decision made in a historical case. For example, a decision made in a historical case may be a numerical value (e.g., a level of action response), and a decision case feature describing such decision may comprise a numerical value. In some instances, a decision recommendation generated and provided by various embodiments of the present disclosure may be assigned or associated with an input case as a decision case feature, and the input case may then be considered or used as a historical case. It may be appreciated then that decision case features may describe a decision or a decision recommendation to defer a historical case (e.g., a previous input case), a decision or a decision recommendation to manually review a historical case (e.g., a previous input case), a decision or a decision recommendation to request more information for a historical case (e.g., a previous input case), and/or the like.

The term “graph-based data structure” may refer to a data entity that is configured to describe, store, modify, aggregate, contain, and/or the like, data related to a plurality of cases, such as prior authorization cases. A graph-based data structure may be configured in the structure of a graph, probability graph, knowledge graph, network graph, directed graph, temporally-networked graph, tree, and/or the like. For example, a graph-based data structure comprises a plurality of nodes storing data, and a plurality of edges connecting the plurality of nodes and indicating relationships between data stored in the plurality of nodes. A graph-based data structure may be configured to perform various operations, methods, functions, and/or the like, for processing data related to a plurality of cases. For example, a graph-based data structure is configured to load data (e.g., a case feature) into an appropriate or corresponding node. As another example, a graph-based data structure is configured to collect and output data based at least in part on performing various graph traversal methods (e.g., depth-first search, breadth-first search). Due to the edges between nodes and the general interconnections between data in a graph-based data structure, retrieval of data (e.g., historical case features of a historical case data object) may be accomplished in a rapid, efficient, and/or parallel manner. A graph-based data structure may be stored in a database comprising a plurality of memory (e.g., non-volatile memory) locations. For example, a node of a graph-based data structure may be one or more memory locations containing or storing data, and an edge may be a reference, link, or address of another node.

The term “subgraph-based data structure” may refer to a data entity that is configured to describe, store, modify, aggregate, contain, and/or the like, a subset of data of a graph-based data structure. That is, a subgraph-based data structure may be understood as a subset, subgraph, and/or the like of a graph-based data structure. A subgraph-based data structure may comprise a subset of the plurality of nodes of a graph-based data structure and a subset of the plurality of edges of the graph-based data structure, and may thereby be traversable. In some embodiments, a subgraph-based data structure may identify a subset of nodes and edges and/or identify specific portions of data within each node, such that the graph-based data structure may be traversed based at least in part on the subgraph-based data structure.

The term “feature data model” may refer to a data entity that is configured to describe a plurality of historical case features from a plurality of historical case data object, or a subset thereof. A feature data model may be any data structure, embeddings, matrix, array, and/or the like configured to describe historical case features from different historical case data objects. For example, a feature data model may be a two-dimensional matrix, in which historical case features for different historical case data objects are stored. A feature data model may be structured such that historical case features corresponding to a case feature dimension may be co-located, connected, related, organized, and/or the like, and such that historical case features corresponding to a historical case data object may be co-located, connected, related, organized, and/or the like.

The term “historical case cohort” may refer to a data entity that is configured to describe and/or identify one or more historical case data objects that are determined to be similar to an input case data object, or otherwise one or more historical case data objects corresponding to historical cases similar to an input case. In various embodiments, the historical case cohort is configured to describe one or more historical case data objects selected from a plurality of historical case data objects. For example, the historical case cohort describes one or more historical case data objects selected based at least in part on high similarity values. In various embodiments, a historical case cohort may be a data structure, an n-order tensor, embeddings, and/or the like. In various embodiments, a historical case cohort is an array of historical case data objects. For example, a historical case cohort is an array of size M×N configured to store M number of historical case data objects each having a length less than or equal to N. As another example, a historical case cohort is an array of identifiers, links, references, addresses, and/or the like of historical case data objects. In various embodiments, a historical case cohort describes one or more historical case data objects by storing one or more corresponding historical feature data objects.

The term “recommendation data object” may refer to a data entity configured to describe a recommendation and contextual information for a particular decision to be made for an input case, such as a prior authorization case. The recommendation data object may be provided to a user to aid in making a decision for the input case. As previously mentioned, various embodiments of the present disclosure may be provided with an input case, or an input case data object describing an input case. The input case may a prior authorization case where an approval or denial decision has not been made and may be provided to various embodiments of the present disclosure in order to obtain a recommendation for a particular decision. In various embodiments, the recommendation data object comprises a decision recommendation that may be a positive decision recommendation (e.g., approve an input prior authorization case) or a negative decision recommendation (e.g., deny an input prior authorization case). In some embodiments, the decision recommendation may be a data object comprising a decision case feature and configured to be interpreted as a recommendation. In some embodiments, the decision recommendation may be a decision case feature, and the decision case feature may be assigned to the input case. It will be understood that the recommendation data object may comprise a decision recommendation that is non-binary in nature, and may include recommended decision levels. In various embodiments, the recommendation data object further comprises a confidence score. In various embodiments, the recommendation data object further comprises a consequence prediction data object configured to describe predicted outcomes resulting from particular decisions made for the input case. In various embodiments, the recommendation data object is configured as a data structure, n-order tensor, embeddings, and/or the like, to describe a determined recommendation for a particular decision for an input case.

### III. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SWIM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

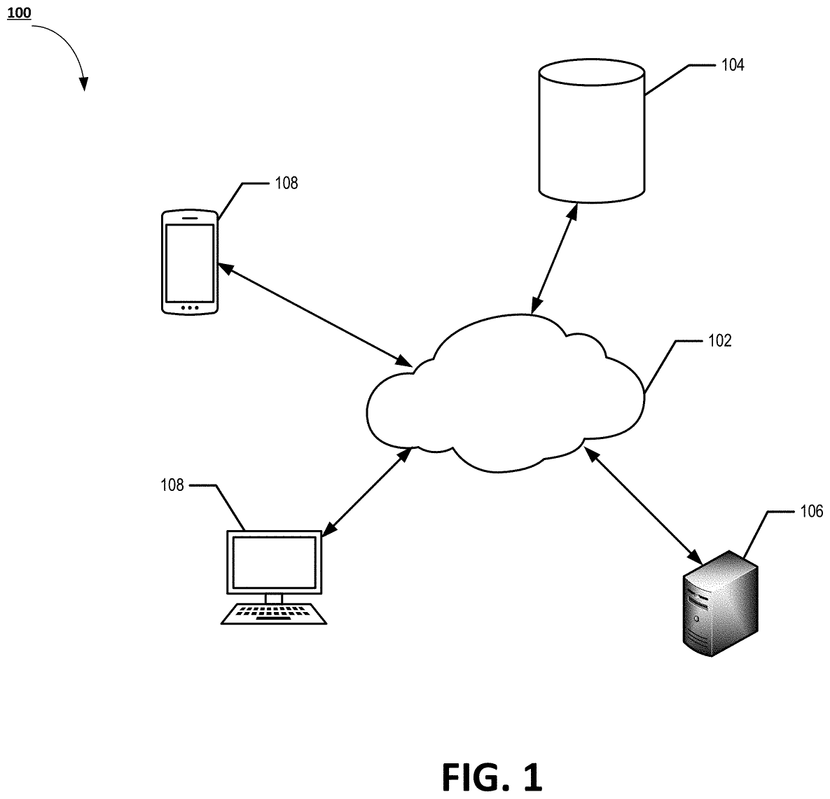

FIG. 1 provides a schematic diagram of an example system 100 for providing a decision recommendation for a case of interest. The example system 100 comprises a system computing entity 106 and one or more client computing entities 108. The example system 100 further comprises one or more databases 104. The system computing entity 106, one or more client computing entities 108, and one or more databases 104 may communicate with one another via network 102.

In various embodiments, a system computing entity 106 is configured to provide a recommendation for a decision for an input case. For example, the input case is a prior authorization case, and the system computing entity 106 recommends an approval decision for the prior authorization case or a denial decision for the prior authorization case. In various embodiments, the system computing entity 106 determines and provides a recommendation based at least in part on a graph-based data structure and a historical case cohort. According to an example embodiment, the system computing entity 106 receives an input case data object comprising one or more input case features describing the input case; generates an input feature data object based at least in part on the one or more input case features; selects a subgraph-based data structure from a graph-based data structure associated with a plurality of historical case data objects, wherein the subgraph-based data structure identifies a subset of historical case data objects of the plurality of historical case data objects; generates a feature data model based at least in part on performing one or more graph traversal operations on the subgraph-based data structure; generates a historical feature data object for each of the subset of historical case data objects based at least in part on the feature data model; selects a historical case cohort identifying one or more historical case data objects of the plurality of historical case data objects based at least in part on comparing a plurality of historical feature data objects to the input feature data object; and/or provides a recommendation data object for the input case data object based at least in part on the selected historical case cohort.

In various embodiments, the system computing entity 106 is a cloud-based computing system. For example, the system computing entity 106 comprises one or more computing devices each configured to share and allocate computer processing resources and data. In various embodiments, the system computing entity 106 is configured to receive an input case data object and provide a recommendation data object for the input case data object. For example, the system computing entity 106 receives an Application Programming Interface (API) call comprising the input case data object from a client computing entity 108 via network 102, and transmits an API response comprising the recommendation data object via network 102 such that the client computing entity 108 receives the API response comprising the recommendation data object. For example, the system computing entity 106 receives a reference, link, address, and/or the like, to an input case data object stored in database 104, and associates or assigns a recommendation data object to the input case data object in the database 104 such that the recommendation data object is provided to one or more client computing entities 108.

In various embodiments, the client computing entity 108 is a mobile device, laptop, desktop, workstation, personal digital assistant, and/or the like. The client computing entity 108 may be configured to receive an input case data object and provide a recommendation data object for an input case data object. For example, the client computing entity 108 receives an input case data object via user input through a user interface, and provides a recommendation data object through the user interface. According to an example embodiment, the client computing entity 108 receives an input case data object comprising one or more input case features describing the input case; generates an input feature data object based at least in part on the one or more input case features; selects a subgraph-based data structure from a graph-based data structure associated with a plurality of historical case data objects, wherein the subgraph-based data structure identifies a subset of historical case data objects of the plurality of historical case data objects; generates a feature data model based at least in part on performing one or more graph traversal operations on the subgraph-based data structure; generates a historical feature data object for each of the subset of historical case data objects based at least in part on the feature data model; selects a historical case cohort identifying one or more historical case data objects of the plurality of historical case data objects based at least in part on comparing a plurality of historical feature data objects to the input feature data object (e.g., one or more historical case data objects with high similarity with the input case data object based at least in part on the comparison are selected); and/or provides a recommendation data object for the input case data object based at least in part on the selected historical case cohort.

The database 104 may be configured to contain or store data, such as various data objects, data values, data structures, and/or the like described herein. In various embodiments, the database 104 is a graph database or a graph-based data structure database configured to store a graph or graph-based data structure. For example, a database 104 is configured to store a graph-based data structure comprising a plurality of nodes and a plurality of edges connecting the nodes and/or indicating relationships between the nodes. In various embodiments, the database 104 is a historical case database configured to store data and historical case features describing and corresponding to a plurality of historical cases. In various embodiments, the database 104 comprises a graph database and a historical case database. In an example embodiment, the system 100 comprises a database 104 configured to store graph-based data structure and a plurality of historical cases. The database 104 may be configured to modify and/or provide data. For example, the database 104 receives instructions from a system computing entity 106 and/or a client computing entity 108 to generate, modify, store, and/or the like, data, data values, and/or data objects, and the database 104 enables access to data such that the data is provided to a system computing entity 106 and/or a client computing entity 108. In an example embodiment, at least a portion of a graph-based data structure is stored in the system computing entity 106 and/or the client computing entity 108.

### Exemplary Computing Entities

In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

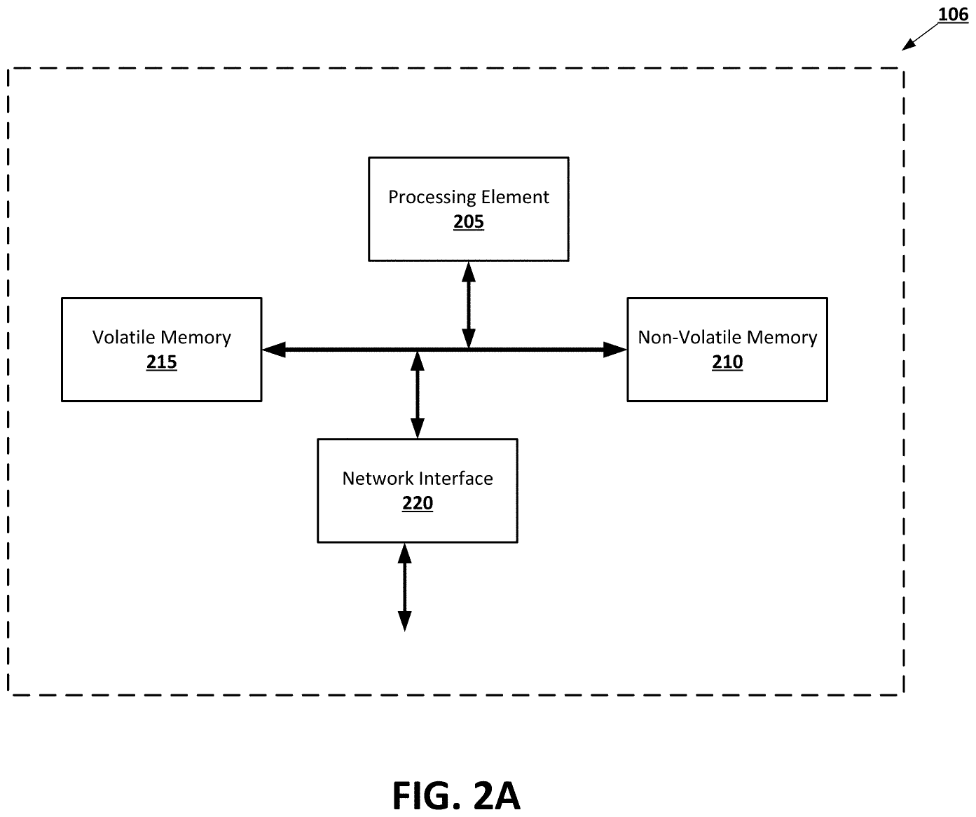

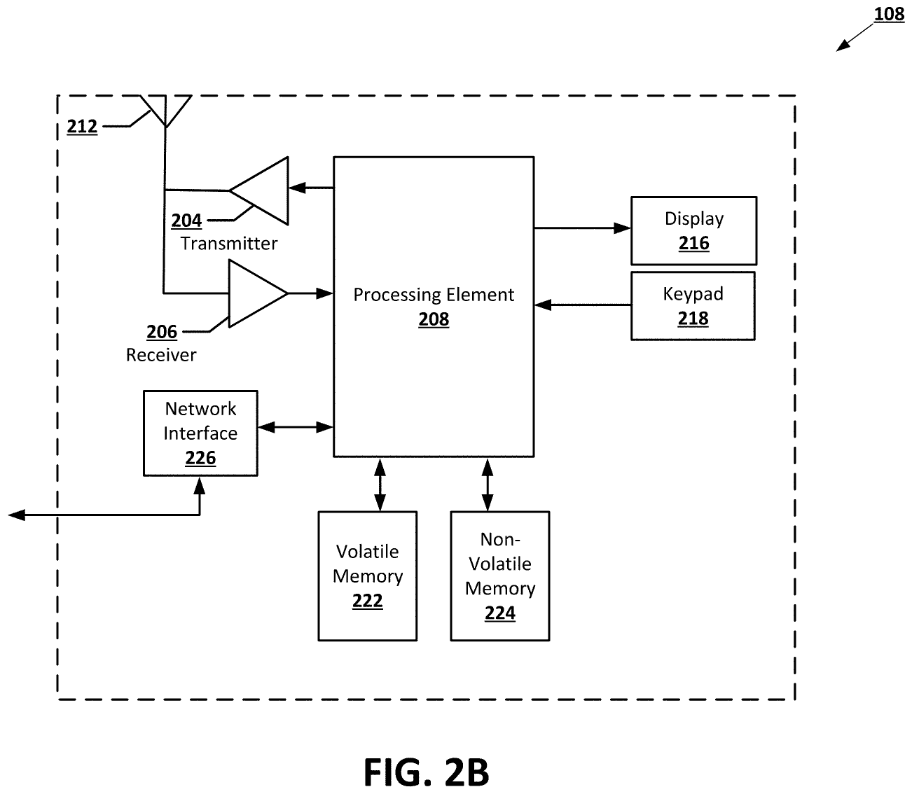

FIG. 2A provides a schematic of a system computing entity 106, according to one embodiment of the present disclosure. As shown in FIG. 2A, in one embodiment, the system computing entity 106 may include, or be in communication with, one or more processing elements 205 (also referred to as processors, processing circuitry, and/or similar terms used herein interchangeably) that communicate with other elements within the system computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the system computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media 210 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In one embodiment, the system computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, DIMM SIMM, VRAM, cache memory, register memory, and/or the like.

As will be recognized, the volatile storage or memory media 215 may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the system computing entity 106 with the assistance of the processing element 205 and operating system.

As indicated, in one embodiment, the system computing entity 106 may also include one or more network interfaces 220 for communicating with various computing entities (e.g., one or more other system computing entities 106, one or more client computing entities 108), such as by communicating data, content, information, and/or similar terms used herein interchangeably that can be transmitted, received, operated on, processed, displayed, stored, and/or the like. The system computing entity 106 may also communicate with one or more databases 104 via the one or more network interfaces 220. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the system computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1x (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the system computing entity 106 may include, or be in communication with, one or more input elements, such as a keyboard input, a mouse input, a touch screen/display input, motion input, movement input, audio input, pointing device input, joystick input, keypad input, and/or the like. The system computing entity 106 may also include, or be in communication with, one or more output elements (not shown), such as audio output, video output, screen/display output, motion output, movement output, and/or the like.

FIG. 2B provides a schematic of an example client computing entity 108 that may be used in conjunction with embodiments of the present disclosure. Client computing entities 108 can be operated by various parties, and the system 100 may include one or more client computing entities 108. As shown in FIG. 2B, the client computing entity 108 can include an antenna 212, a transmitter 204 (e.g., radio), a receiver 206 (e.g., radio), and a processing element 208 (e.g., CPLDs, microprocessors, multi-core processors, coprocessing entities, ASIPs, microcontrollers, and/or controllers) that provides signals to and receives signals from the transmitter 204 and receiver 206, correspondingly.

The signals provided to and received from the transmitter 204 and the receiver 206, correspondingly, may include signaling information/data in accordance with air interface standards of applicable wireless systems. In this regard, the client computing entity 108 may be capable of operating with one or more air interface standards, communication protocols, modulation types, and access types. More particularly, the client computing entity 108 may operate in accordance with any of a number of wireless communication standards and protocols, such as those described above with regard to the system computing entity 106. In a particular embodiment, the client computing entity 108 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 108 may operate in accordance with multiple wired communication standards and protocols, such as those described above with regard to the system computing entity 106 via a network interface 226.

Via these communication standards and protocols, the client computing entity 108 can communicate with various other entities (e.g., system computing entities 106, database 104) using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 108 can also download changes, add-ons, and updates, for instance, to its firmware, software (e.g., including executable instructions, applications, program modules), and operating system.

According to one embodiment, the client computing entity 108 may include location determining aspects, devices, modules, functionalities, and/or similar words used herein interchangeably. For example, the client computing entity 108 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 108 position in connection with a variety of other systems, including cellular towers, Wi-Fi access points, and/or the like. Similarly, the client computing entity 108 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 108 may also comprise a user interface (that can include a display 216 coupled to a processing element 208) and/or a user input interface (coupled to a processing element 208 ). For example, the user interface may be a user application, browser, user interface, and/or similar words used herein interchangeably executing on and/or accessible via the client computing entity 108 to interact with and/or cause display of information/data from the system computing entity 106, as described herein. The user input interface can comprise any of a number of devices or interfaces allowing the client computing entity 108 to receive data, such as a keypad 218 (hard or soft), a touch display, voice/speech or motion interfaces, or other input device. In embodiments including a keypad 218, the keypad 218 can include (or cause display of) the conventional numeric (0-9) and related keys (#, *), and other keys used for operating the client computing entity 108 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 108 can also include volatile storage or memory 222 and/or non-volatile storage or memory 224, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 108. As indicated, this may include a user application that is resident on the entity or accessible through a browser or other user interface for communicating with the system computing entity 106, various other computing entities, and/or a database 104.

In another embodiment, the client computing entity 108 may include one or more components or functionality that are the same or similar to those of the system computing entity 106, as described in greater detail above. As will be recognized, these architectures and descriptions are provided for exemplary purposes only and are not limiting to the various embodiments.

In various embodiments, the client computing entity 108 may be embodied as an artificial intelligence (AI) computing entity, such as an Amazon Echo, Amazon Echo Dot, Amazon Show, Google Home, and/or the like. Accordingly, the client computing entity 108 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

Various embodiments of the present disclosure address technical challenges related to providing a recommendation for a decision for an input case. For example, various embodiments generate and provide a recommendation data object for an input case data object, where the recommendation data object indicates a recommendation for a decision for an input prior authorization case. Various embodiments generate a graph-based data structure and perform graph traversal methods to efficiently provide a recommendation data object.

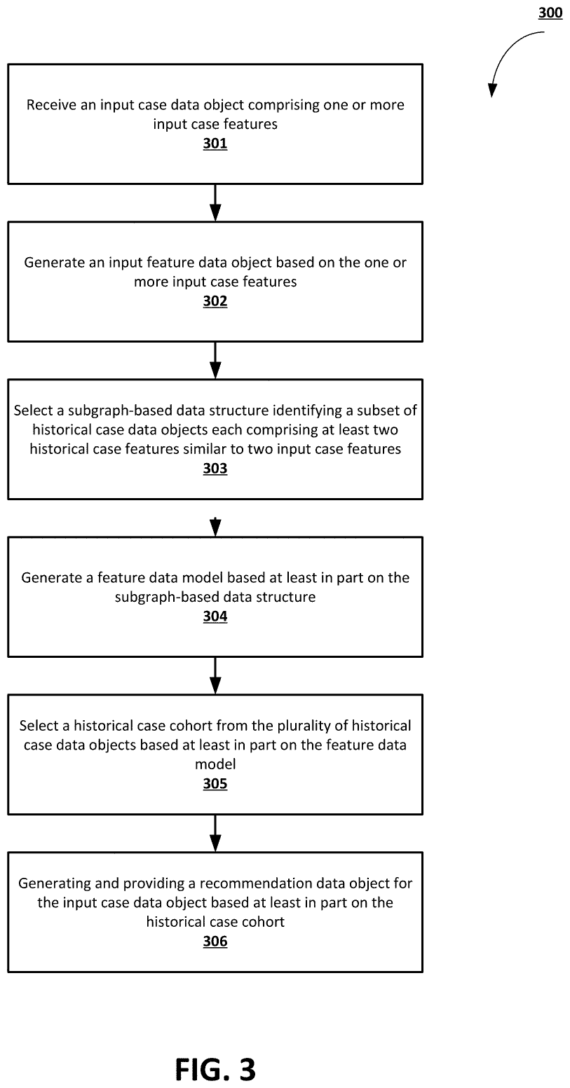

FIG. 3 provides a flowchart diagram of an example process 300 for providing a recommendation data object for an input case data object, according to an embodiment of the present disclosure. Process 300 begins with operation 301, which comprises receiving an input case data object comprising one or more input case features describing an input case (e.g., an input prior authorization case). In various embodiments, system computing entity 106 and/or client computing entity 108 may comprise means, such as processing elements 205, 208, memories 210, 215, 222, 224, network interfaces 220, 226, and/or the like, for receiving an input case data object comprising one or more input case features. For example, system computing entity 106 and/or client computing entity 108 receive an input case data object via network interfaces 220, 226. As another example, system computing entity 106 and/or client computing entity 108 receive or retrieve an input case data object from memories 210, 215, 222, 224. In some embodiments, the process 300 is triggered by receiving an input case data object via an API call. In some embodiments, a plurality of input case data objects are received, and the process 300 is triggered and performed for each input case data object. For example, the process 300 may be performed in parallel for each input case data object.

In various embodiments, the one or more input case features describe one or more dimensions of an input case (e.g., an input prior authorization case). For example, an input case feature configured to describe a patient age dimension of an input case comprises a numerical data value representing an age of the patient of the input case. In various embodiments, the input case data object comprises one or more input case features describing demographic information of the patient. In various embodiments, the input case data object comprises an input case feature describing a diagnosis of the medical condition of the patient and comprising an ICD diagnosis code (e.g., a diagnosis case feature). In various embodiments, the input case data object comprises an input case feature describing a procedure to be performed on the patient or a procedure for which authorization is requested (e.g., in a prior authorization case). The input case feature may comprise a CPT procedure code (e.g., a procedure case feature) describing and/or representative of the procedure to be performed or for which authorization is requested. In an example embodiment, the input case data object comprises a plurality of input case features describing patient age, patient gender, place of service, service setting, provider specialty, patient insurance plan, and/or the like.

In one embodiment, operation 302 may follow operation 301. Operation 302 comprises generating an input feature data object based at least in part on the one or more input case features. In various embodiments, system computing entity 106 and/or client computing entity 108 may comprise means, such as processing elements 205, 208, memories 210, 215, 222, 224, network interfaces 220, 226, and/or the like, for generating an input feature data object based at least in part on the one or more input case features. For example, the system computing entity 106 and/or client computing entity 108 store executable instructions for processing the input case data object and generating an input feature data object for storage in memories 210, 215, 222, 224.

In various embodiments, the input feature data object comprises one or more selected input case features. For example, the input feature data object comprises one or more input case features selected by a machine learning method that classifies the relevance of each input case feature to determining the recommendation for a decision for the input case. As another example, the input feature data object comprises one or more input case features selected via user input through a user interface. For example, a user may select one or more input case features upon which a recommendation for a decision may be based. In various embodiments, the input feature data object may be an embedding of input case features and/or comprise weights corresponding to input case features. In various embodiments, one or more input case features may be selected using dimension reduction techniques or operations (e.g., principal component analysis) that may identify highly relevant input case features, case feature dimensions, or combinations of case feature dimensions.

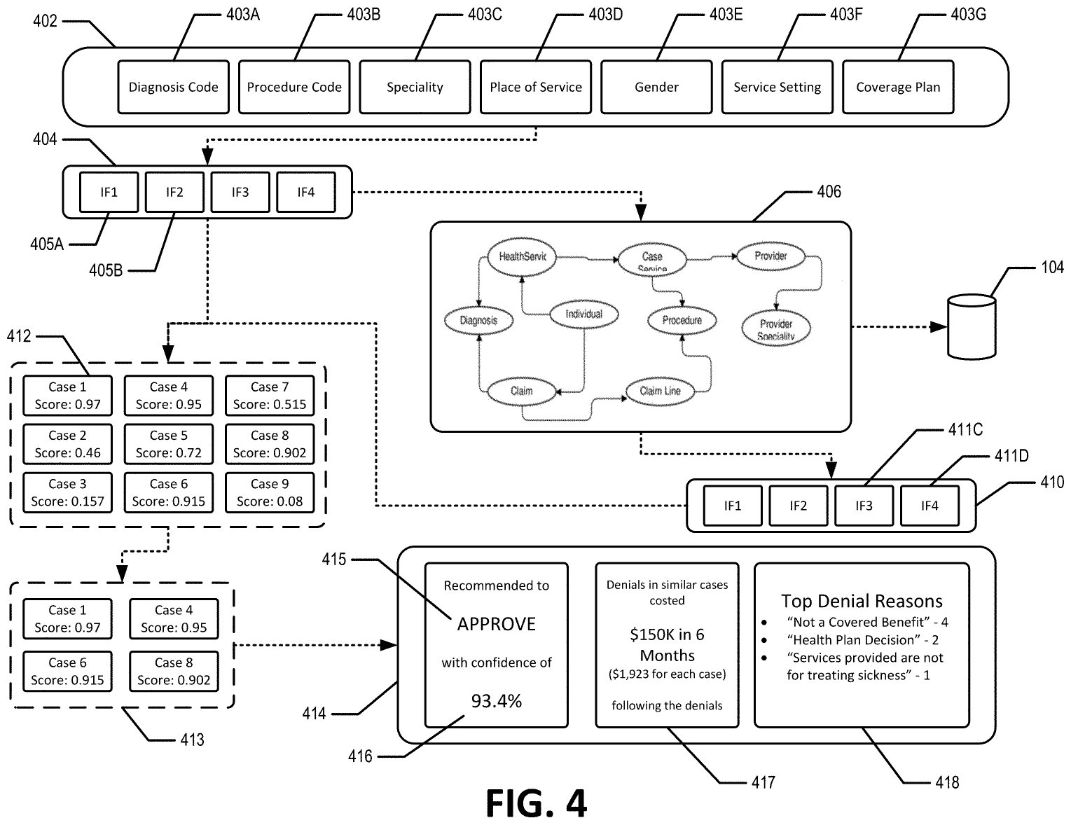

Referring to FIG. 4, a diagram 400 illustrating at least a portion of process 300 is provided. For example, the diagram 400 illustrates an input case data object 402 comprising input case features 403. As previously described, the input case data object 402 may relate to an input prior authorization case, and the input case features 403 each relate to and describe a dimension of the input prior authorization case. In the illustrated embodiment, input case feature 403A describes a diagnosis dimension of the input case and comprises a diagnosis code (e.g., an ICD-10-CM code). Similarly, input case feature 403B describes a procedure dimension of the input case and comprises a procedure code (e.g., a CPT code). As previously described, the procedure code of input case feature 403B may describe or represent a procedure to be performed on the patient or a procedure for which authorization is requested. The illustrated embodiment further comprises input case features 403C-G describing provider specialty, place of service, patient gender, service setting, and patient coverage plan dimensions of the input case, respectively.

The diagram 400 further illustrates an input feature data object 404 generated based at least in part on the input case features 403. The input feature data object 404 comprises one or more input feature elements 405 based at least in part on the input case features 403. In various embodiments, the one or more input feature elements 405 may be and/or may be a subset of the input case features 403. For example, input feature element 405A may be, may comprise, may contain substantially similar values as, and/or the like, input case feature 403C describing a provider specialty. As previously described, input feature elements 405 may be input case features 403 selected via user input, machine learning methods, and/or the like. In various embodiments, the one or more input feature elements 405 may be reduced dimensionality representations of the input case features 403. For example, the input feature data object 404 and input feature elements 405 are generated by performing principal component analysis, linear discriminant analysis, and/or other dimensionality reducing methods on the input case data object 402 and input case features 403.

Returning to FIG. 3, the process 300 may continue to operation 303. Operation 303 comprises selecting a subgraph-based data structure identifying a subset of historical case data objects each comprising at least two historical case features similar to two input case features 403. In various embodiments, the subgraph-based data structure is a subset of a larger graph-based data structure. The graph-based data structure comprises a plurality of nodes, each node corresponding to a dimension spanning a plurality of historical case data objects and comprising, containing, storing, and/or the like, data from the plurality of historical case data objects. Accordingly, the subgraph-based data structure may comprise data from a subset of historical case data objects of the plurality of historical case data objects. In various embodiments, the subset of historical case data objects each have the same diagnosis code and the same procedure code as the input case data object. In other words, each of the subset of historical case data objects comprises a historical case feature substantially similar to an input case feature 403 in a diagnosis case feature dimension, and a historical case feature substantially similar to an input case feature in a procedure case feature dimension. In various embodiments, system computing entity 106 and/or client computing entity 108 may comprise means, such as processing elements 205, 208, memories 210, 215, 222, 224, network interfaces 220, 226, and/or the like, for selecting a graph-based data structure identifying a subset of historical case data objects. For example, system computing entity 106 and/or client computing entity 108 writes data to and/or reads data from a database 104 (e.g., a graph database or graph-based data structure database) via network interfaces 220, 226.

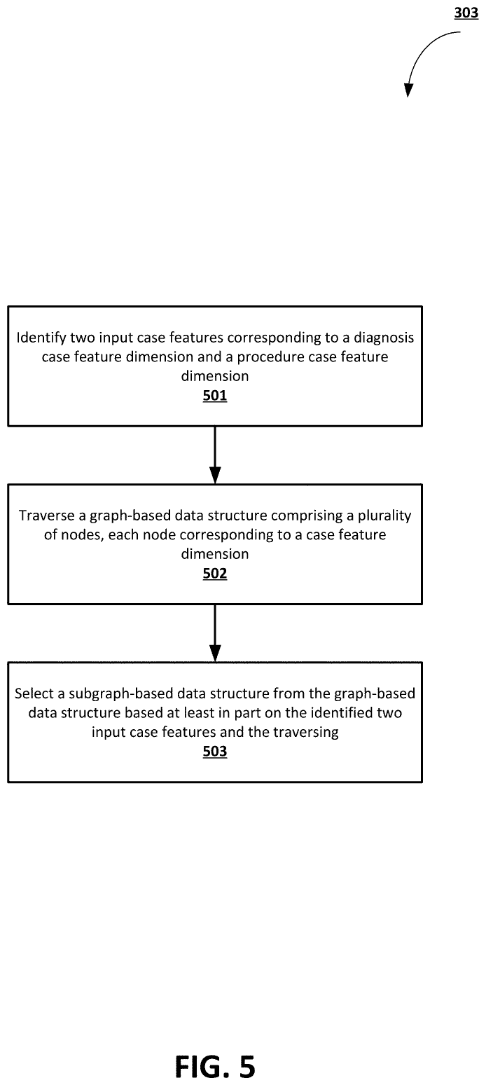

FIG. 5 provides an example process for performing operation 303. That is, FIG. 5 provides an example embodiment of selecting a subgraph-based data structure identifying a subset of historical case data objects from a graph-based data structure associated with a plurality of historical case data objects. As discussed, operation 303 of selecting a subgraph-based data structure may be performed dynamically and responsive to receiving additional input case data objects. A subgraph-based data structure may correspond to and/or be unique to a particular input case in order to provide a decision recommendation generated specifically for the particular input case. Specifically, a subgraph-based data structure may be selected based at least in part on input case features 403 (e.g., a diagnosis code and a procedure code) of a particular input case, and thereby may be unique to the particular input case. As such, operation 303 may be performed—and the example embodiment of operation 303 provided in FIG. 5—in a dynamic manner for subsequently received input case data objects.

The provided example embodiment of operation 303 may begin at operation 501, which comprises identifying two input case features 403 corresponding to a diagnosis case feature dimension and a procedure case feature dimension. As previously described, an input case feature 403 corresponding to a diagnosis case feature dimension may describe a diagnosis made by a healthcare provider for a patient in the input case (e.g., a prior authorization case), and meanwhile, an input case feature 403 corresponding to a procedure case feature dimension may describe a procedure to be performed on a patient or for which an authorization is requested. For example, in one embodiment, an input case feature 403 corresponding to a diagnosis case feature dimension is a diagnosis code (e.g., ICD code), and an input case feature 403 corresponding to a procedure case feature dimension is a procedure code (e.g., CPT code). In various embodiments, system computing entity 106 and/or client computing entity 108 may comprise means, such as processing elements 205, 208, memories 210, 215, 222, 224, network interfaces 220, 226, and/or the like, for identifying two input case features corresponding to a diagnosis case feature dimension and a procedure case feature dimension. For example, system computing entity 106 and/or client computing entity 108 processes the input case data object, and identifies an input case feature corresponding to a diagnosis case feature dimension and an input case feature corresponding to a procedure case feature dimension. In an example embodiment, the system computing entity 106 and/or the client computing entity 108 receives an indication of two input case features, and/or receives the two input case features from a database 104 via network interfaces 220, 226.

In one embodiment, operation 502 may then follow operation 501. Operation 502 comprises traversing a graph-based data structure comprising a plurality of nodes, each node corresponding to a case feature dimension. In various embodiments, system computing entity 106 and/or client computing entity 108 may comprise means, such as processing elements 205, 208, memories 210, 215, 222, 224, network interfaces 220, 226, and/or the like, for traversing a graph-based data structure comprising a plurality of nodes. For example, system computing entity 106 and/or client computing entity 108 transmits instructions such that a database 104 (e.g., a graph database or a graph-based data structure database) receives the instructions and retrieves data from a node of the graph-based data structure. In various embodiments, the graph-based data structure is stored and/or located in a database 104. In an example embodiment, at least a portion of the graph-based data structure is generated and/or stored in memories 210, 215, 222, 224 of system computing entity 106 and/or client computing entity 108. In various embodiments, system computing entity 106 generates and transmits an API call to traverse the graph-based data structure.

In various embodiments, the graph-based data structure comprises data for a plurality of historical case data objects. Similar to the input case data object, historical case data objects are configured to describe historical cases, such as historical prior authorization cases. The historical case data objects comprise historical case features describing the historical cases. Historical cases are associated with a historical point in time prior to a point in time associated with the input case, and further are associated with a historically-made decision. For example, a historical prior authorization case is associated with an approval decision or a denial decision previously made at a historical point in time. As such, a historical case data object comprises a decision case feature, or a historical case feature describing a decision dimension of a corresponding historical case. An example historical case data object may comprise a negative decision case feature indicating that the corresponding historical case was previously denied. Likewise, a historical case data object comprising a positive decision case feature may indicate that the corresponding historical case was approved. It will be appreciated that decision case features may be configured to describe non-binary decisions, such as by comprising numerical values to describe decision or evaluation levels of a historical case. In various embodiments, historical case data objects comprise other historical case features that describe the historical cases, such as historical case features that describe patient age, patient gender, provider service, place of setting, and/or the like.

Thus, the graph-based data structure comprises a plurality of nodes each corresponding to a case feature dimension and storing historical case features of a corresponding case feature dimension from the plurality of historical case data objects. The graph-based data structure further comprises a plurality of edges connecting the plurality of nodes and indicating relationships between the plurality of nodes. As such, data of the plurality of historical case data objects may be interconnected or interrelated, and traversal of the graph-based data structure in operation 502 may be a rapid and efficient technique to identify, locate, and/or retrieve data from different case feature dimension for the plurality of historical case data objects.

In one embodiment, operation 503 may then follow operation 502. Operation 503 comprises selecting a subgraph-based data structure from the graph-based data structure based at least in part on the identified two input case features and the traversing. As described, the subgraph-based data structure may be a subset of the graph-based data structure and may comprise data for a subset of the plurality of historical case data objects. The subgraph-based data structure may comprise a subset of the plurality of nodes of the graph-based data structure, as the subset of historical case data objects may not have historical case features for each and every case feature dimension represented by the plurality of nodes of the graph-based data structure. In various embodiments, the subgraph-based data structure is selected based at least in part on traversing the graph-based data structure to identify a subset of historical case data objects with a historical case feature substantially similar to an input case feature in a diagnosis case feature dimension and a historical case feature substantially similar to an input case feature in a procedure case feature dimension. In various embodiments, the subgraph-based data structure may be copied and/or stored separately from the graph-based data structure. In other embodiments, the subgraph-based data structure may be identified by a specific identification of nodes and edges of the graph-based data structure relevant to the subgraph-based data structure.

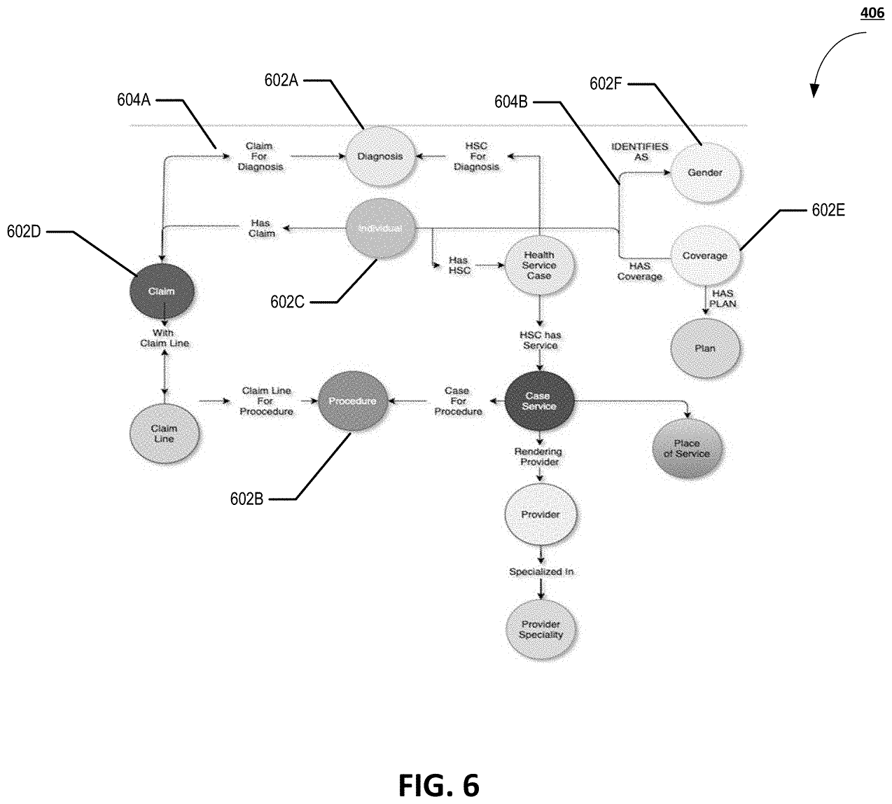

FIG. 6 provides an example graph-based data structure 406. The graph-based data structure 406 comprises a plurality of nodes 602, as well as a plurality of edges 604 connecting the plurality of nodes 602 and indicating relationships between the plurality of nodes 602. In various embodiments, the graph-based data structure 406 is traversed in the example process illustrated in FIG. 5 to select a subgraph-based data structure corresponding to and identifying historical case data objects comprising at least two historical case features substantially similar to two input case features. As previously discussed, the subgraph-based data structure may be dynamically selected responsive to the input case data object being received, and may also correspond to the input case data object or the input case, as the subgraph-based data structure is selected based at least in part on input case features. That is, an additional subgraph-based data structure may be dynamically selected for an additional input case data object in order to generate and provide a decision recommendation unique to an additional input case associated with the additional input case data object.

In the illustrated embodiment, the graph-based data structure 406 comprises a plurality of nodes 602 each corresponding to a historical case feature dimension. For example, node 602A corresponds to a diagnosis case feature dimension, node 602B corresponds to a procedure case feature dimension, node 602C corresponds to a patient individual case feature dimension, node 602D corresponds to a claim case feature dimension, node 602E corresponds to a patient coverage dimension, node 602F corresponds to a patient gender dimension, and so on. As aforementioned, a subset of historical case data objects may be identified, where each historical case data object has the substantially same case feature in at least two dimensions as the input case data object based at least in part on traversing the graph-based data structure 406. In various embodiments, each identified historical case data object comprises the same diagnosis case feature and the same procedure case feature as the input case data object. For example, an input case data object 402 may comprise a diagnosis case feature describing and/or comprising an ICD code J12.82 (indicating that the patient of the input case has been diagnosed with pneumonia due to coronavirus disease 2019) and a procedure case feature describing and/or comprising a CPT code 87426 (indicating that an antigen test for the COVID-19 virus was performed on the patient of the input case). Therefore, a subset of historical case data objects comprising a diagnosis case feature describing and/or comprising the ICD code J12.82 and a procedure case feature describing and/or comprising the CPT code 87426 may be identified via traversal of the graph-based data structure 406, and a subgraph-based data structure may be selected to identify and/or to store data for the subset of historical case data objects.

Each node 602 may comprise historical case features in accordance with the corresponding dimensions. Following the example involving ICD code J12.82 and CPT code 87426, it will then be appreciated that node 602A corresponding to the diagnosis case feature dimension may store a plurality of historical case features, a subset of which describing and/or comprising the ICD code J12.82, and node 602B corresponding to the procedure case feature dimension may store a plurality of historical case features, a subset of which describing and/or comprising the CPT code 87426. For example, node 602C may store a plurality of unique patient individual identifiers (e.g., first and last names, birthdates, Social Security numbers, member numbers, and/or the like) extracted from the plurality of identified historical case data objects.

In various embodiments, historical case features can be indexed, organized, configured, and/or the like based at least in part on corresponding historical case data objects across the nodes 602. For instance, a first historical case data object comprising a patient gender case feature of “female” and a patient individual identifier of “Jane Doe” and a second historical case data object comprising a patient gender case feature of “male” and a patient individual identifier of “John Smith” may be stored in the graph-based data structure 406, such that “female” and “Jane Doe” are stored in respective first indexes of nodes 602F and 602C and “male” and “John Smith” are stored in respective second indexes of nodes 602F and 602C. In various embodiments, historical case features are stored in hashed indexes of nodes 602. Thus, it may be appreciated in any embodiment, historical case features can be stored within nodes 602 in a manner such that historical case features for a given historical case data object can reliably be extracted, collected, obtained, and/or the like. Thus, the selected subgraph-based data structure may comprise one or more indices corresponding to the subset of historical case data objects, such that data from the subset of historical case data objects may be retrieved by referencing the one or more indices while traversing the selected subgraph-based data structure and/or the graph-based data structure 406.

In various embodiments, the graph-based data structure 406 comprises a node 602 corresponding to a decision case feature dimension. Although this node 602 is not explicitly illustrated in FIG. 6, this node 602 may be connected to a node 602 corresponding to the historical prior authorization request or case (e.g., the node 602 labelled Health Service Case. As such, this node 602 corresponding to the decision case feature dimension may be traversed to from a node 602 describing and corresponding to a relevant historical prior authorization request or case. This node 602 may store historical decision case features from the identified plurality of historical case data objects. For example, this node 602 may store a first decision case feature that is a positive decision case feature from a first historical case data object corresponding to a first historical prior authorization case that was approved, and may store a second decision case feature that is a negative decision case feature from a second historical case data object corresponding to a second historical prior authorization case that was denied. Accordingly, the selected subgraph-based data structure may comprise a corresponding node corresponding to a decision case feature dimension, identify indices within the node 602 of the graph-based data structure 406 corresponding to a decision case feature dimension, and/or the like, such that the selected subgraph-based data structure identifies decision case features of a subset of historical case data objects comprising the same diagnosis code and the same procedure code as the input case data object.

The graph-based data structure 406 comprises a plurality of edges 604 indicating a relationship between various nodes 602. In the illustrated embodiment, for example, edge 604A indicates a relationship between the node 602A corresponding to a diagnosis case feature dimension and the node 602D corresponding to a claim case feature dimension. Indeed, edge 604A may indicate that insurance claims may include diagnoses codes, for example. Likewise, edge 604B indicates a relationship between the node 602C corresponding to a patient individual case feature dimension and the node 602F corresponding to a patient gender dimension. For example, edge 604B indicates that the patient individuals described by historical case features stored in node 602C identify as genders described by historical case features stored in node 602F.

In various embodiments, the plurality of edges 604 enable the use of graph traversal methods on the graph-based data structure 406 to identify a subset of historical case data objects with the same diagnosis code and the same procedure code as the input case data object and to select a subgraph-based data structure identifying the subset. In various embodiments, graph traversal methods are used and performed on graph-based data structure 406 to search for, collect, obtain, and/or the like data stored within nodes 602. For example, a graph traversal method may comprise, given a historical case feature stored in node 602C describing a patient individual, traversing edge 604B to collect or obtain a historical case feature stored in node 602F describing a gender for the patient individual. The selected sub-graph based data structure may also comprise edges and/or may identify edges, such that the selected sub-graph based data structure may be traversed to collect or obtain historical case features for the subset of historical case data objects.

Returning to the example process 300 provided by FIG. 3, operation 304 is then performed. Operation 304 comprises generating a feature data model or data structure based at least in part on the subgraph-based data structure. As discussed, the subgraph-based data structure may comprise, store, and/or identify data for a subset of historical case data objects each comprising at least two historical case features similar to two input case features. In various embodiments, the feature data model may be generated based at least in part on traversing the subgraph-based data structure to collect, obtain, or retrieve historical case features for the subset of historical case data objects. In various embodiments, the subgraph-based data structure may identify various nodes and indices within nodes, such that a feature data model is generated based at least in part on traversing the subgraph-based data structure through the identified nodes and indices within nodes. Thus, in various embodiments, the feature data model comprises historical case features from the subset of historical case data objects identified by the subgraph-based data structure. In various embodiments, the feature data model may be a n-order tensor, array, matrix, data structure, and/or the like configured to store historical case features from the subset of historical case data objects.

In one embodiment, operation 305 may follow operation 304. Operation 305 comprises selecting a historical case cohort from the subset of historical case data objects based at least in part on the feature data model. As previously discussed, each of the subset of historical case data objects comprise a diagnosis code the same as a diagnosis code of the input case data object and a procedure code the same as a procedure code of the input case data object, in various embodiments. In various embodiments, system computing entity 106 and/or client computing entity 108 may comprise means, such as processing elements 205, 208, memories 210, 215, 222, 224, network interfaces 220, 226, and/or the like, for selecting a historical case cohort from the subset of historical case data objects based at least in part on the feature data model. For example, system computing entity 106 communicates with a database 104 (e.g., a graph database, graph-based data structure database, a historical case database) via network interface 220 to select one or more historical case data objects.

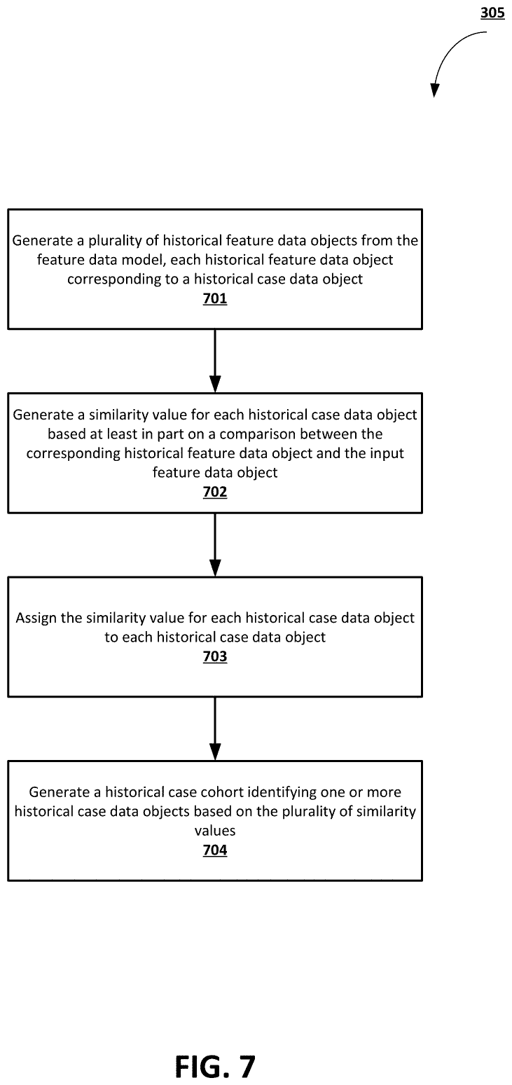

An example embodiment of operation 305 is provided in FIG. 7. Indeed, FIG. 7 provides an example process for selecting a historical case cohort from the subset of historical case data objects. For example, system computing entity 106 and/or client computing entity 108 may begin with performing operation 701, which comprises generating a plurality of historical feature data objects based at least in part on the feature data model. For example, system computing entity 106 and/or client computing entity 108 may comprise means, such as processing elements 205, 208, memories 210, 215, 222, 224, network interfaces 220, 226, and/or the like, for generating a plurality of historical feature data objects based at least in part on the feature data model. For example, the system computing entity 106 may access data stored in a database 104 (e.g., a graph database, a graphically-structured database, a historical case database) and receive data for generating a historical feature data object via network interface 220.

Each historical feature data object corresponds to a historical case data object and describes historical case features of the historical case data object. The diagram 400 of FIG. 4 illustrates an example historical feature data object 410 comprising historical feature elements 411. As will be appreciated from the diagram 400, historical feature data objects 410 may be similar and/or based at least in part on input feature data objects 404. For example, historical feature data objects 410 are generated to have the same number of historical feature elements 411 as the number of input feature elements 405 in the input feature data object 404. It may be appreciated that historical feature data objects 410 may be generated by extracting historical case features similar to and/or in the same dimension of input case features 403 of the input case. In an example embodiment, historical feature elements 411 are reduced dimension representations of historical case features in the same reduced dimensions as input feature elements 405.

The historical feature elements 411 may be based at least in part on historical case features extracted from historical case data objects by traversing the subgraph-based data structure to generate a feature data model. In various embodiments, the one or more historical feature elements 411 of a historical feature data object 410 may be and/or may be a subset of the historical case features of a corresponding historical case data object. For example, input feature elements 405 may be input case features 403 selected via client input, machine learning methods, and/or the like, and therefore, historical feature elements 411 of a historical feature data object 410 may be historical case features of the same dimension as the selected input case features 403 (and obtained from the feature data model and/or via traversing the subgraph-based data structure). In various embodiments, the one or more input feature elements 405 may be reduced dimensionality representations of the input case features 403, and the historical feature elements 411 may be the same reduced dimensionality representations of historical case features. In general then, it will be understood that the historical feature data object 410 may be generated based at least in part on the input feature data object 404 and on traversing the subgraph-based data structure.

It may also be appreciated that a plurality of historical feature data objects 410 may be generated efficiently and/or at substantially the same time due to each node 602 of the subgraph-based data structure storing historical case features of the subset of historical case data objects.

For example, when traversing each node 602 of the subgraph-based data structure, historical case features from the subset of historical case data objects may be obtained to generate the historical feature data objects 410 corresponding to the subset of historical case data objects.

In one embodiment, operation 702 may follow operation 701. Operation 702 comprises generating a similarity value for each historical case data object based at least in part on a comparison between (a) a historical feature data object corresponding to the historical case data object, and (b) the input feature data object. In various embodiments, system computing entity 106 and/or client computing entity 108 may comprise means, such as processing elements 205, 208, memories 210, 215, 222, 224, network interfaces 220, 226, and/or the like, for generating a similarity value for each historical case data object based at least in part on a comparison between (a) a historical feature data object corresponding to the historical case data object, and (b) the input feature data object. For example, a processing element 205 of system computing entity 106 is configured to perform operations and functions to compare the historical feature data object and the input feature data object.

In various embodiments, the plurality of historical feature data objects—or rather, each historical feature data object—is compared to the input feature data object using cosine similarity. As will be understood by those of skill in the field to which the present disclosure pertains, cosine similarity is configured to describe and quantify a difference between two data objects, such as vectors. For example, given two vectors both of length L, a cosine similarity between the two vectors may be determined by taking the dot product of the two vectors and dividing said dot product by a multiplication of the norms of each vector. Thus, for example, a cosine similarity value between historical feature data object A that is a vector of length L and an input feature data object B that is a vector also of length L can be generated and determined by the following equation:

$$similarity ( A , B ) = \frac{A * B}{‖ A ‖ \times ‖ B ‖} = \frac{{\sum }_{i = 1}^{L} {A}_{i} * {B}_{i}}{\sqrt{{\sum }_{i = 1}^{L} {A}_{i}^{2}} * \sqrt{{\sum }_{i = 1}^{L} {B}_{i}^{2}}} .$$

Indeed, system computing entity 106 and/or client computing entity 108 generates a similarity value that is and/or is based at least in part on a cosine similarity value, in various embodiments. In such embodiments, the cosine similarity value ranges from 0 to 1, where a cosine similarity value of 1 indicating that the data objects being compared are exactly or substantially the same (e.g., maximal similarity). However, it will be understood that other comparison methods that are configured to describe a difference between two data objects—such as a historical feature data object and an input feature data object—and produce a similarity value indicating such difference may be used and performed by system computing entity 106 and/or client computing entity 108.

In one embodiment, operation 703 may follow operation 702. Operation 703 comprises assigning the similarity value for each historical case data object to each historical case data object of the subset of historical case data objects identified by the subgraph-based data structure and the feature data model. In various embodiments, system computing entity 106 and/or client computing entity 108 may comprise means, such as processing elements 205, 208, memories 210, 215, 222, 224, network interfaces 220, 226, and/or the like, for assigning a similarity value to each historical case data object based at least in part on a comparison between a historical feature data object corresponding to the historical case data object, and the input feature data object. For example, the system computing entity 106 and/or client computing entity 108 store computer executable instructions in memories 210, 215, 222, 224 for assigning the similarity value to the historical case data object. For example, the system computing entity 106 and/or client computing entity 108 may concatenate the similarity value to the historical case data object, insert the similarity value into the historical case data object, generate a reference, link, or address to the historical case data object in the corresponding similarity value, generate a reference, link, or address to the corresponding similarity value in the historical case data object, and/or the like.

The diagram provided by FIG. 4 illustrates assigning similarity values 412 for each historical case data object to each historical case data object. In the illustrated embodiment, nine similarity values 412 are generated and assigned to nine different historical cases, or nine historical case data objects. In the illustrated embodiment, the similarity values 412 are cosine similarity values. As discussed, cosine similarity values range from 0 to 1, where a cosine similarity value of 0 indicates that the two data objects being compared have no similarity and a cosine similarity value of 1 indicates that the two data objects being compared are substantially the same. As shown in diagram 400, a first historical case, or a first historical case data object, is assigned with a first cosine similarity value of 0.97. This first cosine similarity value of 0.97 may indicate that a historical feature data object 410 corresponding to the first historical case data object is 97% similar to the input feature data object 404, or at least that the historical feature data object 410 is relatively similar to the input feature data object 404. The diagram 400 continues to illustrate that a second historical case is assigned with a second cosine similarity value of 0.46, a third historical case is assigned with a third cosine similarity value of 0.157, a fourth historical case is assigned with a fourth cosine similarity value of 0.95, and so on.

In one embodiment, operation 704 may then follow operation 703. Operation 704 comprises generating a historical case cohort identifying one or more historical case data objects based at least in part on the plurality of similarity values 412. That is, the historical case cohort is generated based at least in part on similarity values 412 assigned to each of the plurality of historical case data objects. In various embodiments, system computing entity 106 and/or client computing entity 108 may comprise means, such as processing elements 205, 208, memories 210, 215, 222, 224, network interfaces 220, 226, and/or the like, for generating a historical case cohort identifying one or more historical case data objects based at least in part on the plurality of similarity values 412. For example, system computing entity 106 generates a historical case cohort for storage in memories 210, 215. For example, client computing entity 108 generates a historical case cohort in a database 104 via network interface 226.

In various embodiments, the historical case cohort identifies one or more historical case data objects that are deemed to be similar to the input case data object 402, and thereby also identifying one or more corresponding historical cases that are deemed to be similar to the input case. In various embodiments, generating the historical case cohort first comprises ordering, ranking, listing, processing, and/or the like, the plurality of historical case data objects based at least in part on each similarity value 412 assigned to each historical case data object. Subsequently, a pre-determined and configurable number of historical case data objects with the highest similarity value 412 may be selected for the historical case cohort, in an example embodiment. Additionally or alternatively, historical case data objects may be selected based at least in part on a distribution of the plurality of similarity values 412, in various embodiments. For example, the historical case cohort is generated to identify historical case data objects with similarity values 412 in the top tenth percentile of the plurality of similarity values 412. In various embodiments, selection of historical case data objects to be identified by the historical case cohort is based at least in part on a threshold similarity value. For example, in embodiments where the similarity value 412 is a cosine similarity value ranging from 0 to 1, the historical case cohort is generated to identify historical case data objects with assigned similarity values 412 greater than 0.90, or 90% similarity as an example. However, as will be recognized, any suitable value may be used. Diagram 400 of FIG. 4 illustrates an example embodiment of generating a historical case cohort 413 identifying four historical case data objects based at least in part on the plurality of similarity values 412. In the illustrated embodiment, the historical case cohort 413 identifies historical case data objects of the plurality of historical case data objects assigned with similarity values 412 greater than a threshold similarity value of 0.90. Thus, in any embodiment, the historical case cohort 413 identifies one or more historical case data objects assigned with similarity values 412 that satisfy a similarity criteria.

In various embodiments, the historical case cohort 413 is configured to identify the one or more historical case data objects similar to the input case data object 402 by comprising each historical case data objects assigned with similarity values 412 that satisfy a similarity criteria. For example, the historical case cohort 413 is a data entity, data structure, list, linked list, graph, matrix, array, and/or the like, comprising one or more historical case data objects. For example, the historical case cohort 413 is a matrix of M×L size comprising M number of historical case data objects each of size 1×L. In various embodiments, the historical case cohort 413 is a data entity comprising identifiers identifying the one or more historical case data objects.

Returning to the example process 300 provided by FIG. 3, in one embodiment, operation 306 may follow operation 305. For example, operation 306 may follow operation 704 of the example embodiment of operation 305 illustrated in FIG. 7. Operation 306 comprises generating a recommendation data object based at least in part on the historical case cohort 413 and assigning the recommendation data object to the input case data object 402. In various embodiments, system computing entity 106 and/or client computing entity 108 may comprise means, such as processing elements 205, 208, memories 210, 215, 222, 224, network interfaces 220, 226, and/or the like, for generating a recommendation data object based at least in part on the historical case cohort and assigning the recommendation data object to the input case data object 402. For example, system computing entity 106 generates a recommendation data object for storage in memories 210, 215. For example, system computing entity 106 and/or client computing entity 108 comprise computer executable instructions in memories 210, 215, 222, 224, for performing operations for generating a recommendation data object based at least in part on the historical case cohort 413 and assigning the recommendation data object to the input case data object 402.

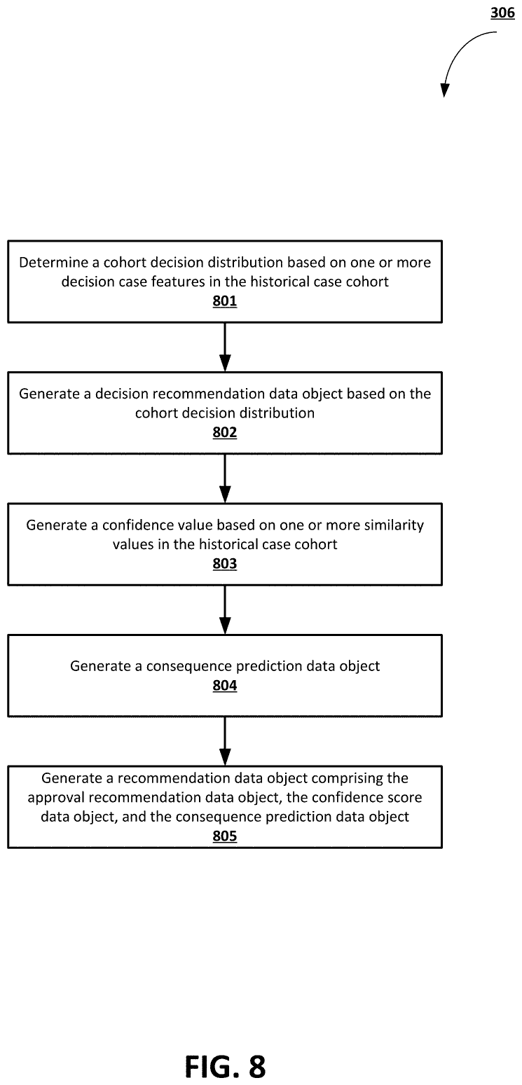

In various embodiments, system computing entity 106 and/or client computing entity may be configured to perform operations illustrated in FIG. 8. Referring to FIG. 8, an example process for performing operation 306 is provided. That is, FIG. 8 provides operations for providing a recommendation data object for the input case data object 402 based at least in part on the historical case cohort. In various embodiments, the provided recommendation data object comprises at least a recommendation of a decision to be made for the input case. Diagram 400 additionally illustrates a recommendation data object 414.

The example process provided by FIG. 8 begins at operation 801. Operation 801 comprises determining a cohort decision distribution based at least in part on one or more decision case features in the historical case cohort 413. Specifically, the historical case cohort 413 identifies and/or comprises one or more historical case data objects, and each historical case data object may comprise a decision case feature. In various embodiments, system computing entity 106 and/or client computing entity 108 may comprise means, such as processing elements 205, 208, memories 210, 215, 222, 224, network interfaces 220, 226, and/or the like, for determining a cohort decision distribution based at least in part on one or more decision case features in the historical case cohort 413. For example, system computing entity 106 accesses the historical case cohort stored in memories 210, 215, and processes the historical case cohort 413 to determine and/or generate a cohort decision distribution.

In various embodiments, the cohort decision distribution is an aggregated indication of the one or more decision case features of the one or more historical case data objects identified by the historical case cohort 413. The cohort decision distribution may describe and indicate the number of historical case data objects comprising each different type or category of decision case features. Returning to the example of prior authorization cases, decision case features may be positive decision case features (e.g., approval of a prior authorization case) or negative decision case features (e.g., denial of a prior authorization case). As such, the cohort decision distribution may comprise a number of historical case data objects comprising a positive decision case feature, a number of historical case data objects comprising a negative decision case feature, a fraction based at least in part on the number of historical case data objects comprising a positive decision case feature out of the total number of historical case data objects identified by the historical case cohort 413 (e.g., a positive decision fraction), a fraction based at least in part on the number of historical case data objects comprising a negative decision case feature out of the total number of historical case data objects identified by the historical case cohort 413 (e.g., a negative decision fraction), and/or the like. In various embodiments where decisions for case are non-binary (e.g., approve, review, and deny a prior authorization case), the cohort decision distribution may similarly comprise various numbers and fractions indicating the distribution of decision case features among historical case data objects identified by the historical case cohort 413. In an example embodiment, the cohort decision distribution is a histogram.

In one embodiment, operation 802 may then follow operation 801. Operation 802 comprises generating a decision recommendation data object based at least in part on the cohort decision distribution. In various embodiments, system computing entity 106 and/or client computing entity 108 may comprise means, such as processing elements 205, 208, memories 210, 215, 222, 224, network interfaces 220, 226, and/or the like, for generating a decision recommendation data object based at least in part on the cohort decision distribution. For example, system computing entity 106 and/or client computing entity 108 can generate a decision recommendation data object for storage in memories 210, 215.

The decision recommendation data object may recommend a decision to be made for the input case. For example, the decision recommendation data object 415 illustrated in diagram 400 recommends a positive decision, or approval, for of an input prior authorization case. As aforementioned, the decision recommended by the decision recommendation data object 415 may be non-binary, such as a decision to either approve, review, or deny an input prior authorization case. The decision recommendation data object may be a decision case feature for the input case, in some embodiments. That is, the decision recommendation data object may be assigned to or otherwise associated with the input case data object similar to how historical case data objects comprise a historical decision case feature.

The decision recommendation data object 415 recommends a decision based at least in part on various values and/or fractions of the cohort decision distribution. For example, the decision recommendation data object 415 recommends a positive decision when a positive decision fraction of the cohort decision distribution is greater than a threshold fraction value. Thus, if a threshold fraction value is 0.50 and more than half of the historical case data objects identified by the historical case cohort comprise a positive decision case feature, then the decision recommendation data object 415 recommends a positive decision (e.g., approve the input prior authorization case). In an example embodiment, the decision recommendation data object 415 recommends a decision based at least in part on a threshold count and the cohort decision distribution. For example, if a positive decision count of the cohort decision distribution (e.g., the number of historical case data objects comprising a positive decision case feature) is greater than or equal to a threshold count, then the decision recommendation data object 415 recommends a positive decision.

In various embodiments, the decision recommendation data object 415 comprises a recommendation other than a positive recommendation or a negative recommendation. In various embodiments, the decision recommendation data object 415 may comprise a neutral or undecided recommendation. For example, the decision recommendation data object 415 may recommend manual (e.g., by a human operator) or additional review for the input prior authorization case. For example, the decision recommendation data object 415 may recommend a neutral decision recommendation when a positive decision fraction value of the cohort decision distribution is between 0.45 and 0.55. As another example, the decision recommendation data object 415 may recommend and/or request additional information or data due to an insufficiency of data to analyze (e.g., relatively low number of historical case data object identified by the historical case cohort 413). For example, the decision recommendation data object 415 may comprise a neutral recommendation, recommend manual review of the input case, and/or recommend and/or request additional information is the historical case cohort identifies a number of historical cases less than a threshold number of historical cases (e.g., the historical case cohort identifies zero historical case data objects, meaning that no historical cases are similar to the input case). Thus, in some embodiments, the decision recommendation data object 415 may be based at least in part on the number of historical case data objects (and by extension, historical cases) identified by the historical case cohort.

In one embodiment, operation 803 may then follow operation 802. Operation 803 comprises generating a confidence value based at least in part on the one or more similarity values 412 of the historical case cohort 413, or more specifically, the one or more similarity values 412 assigned to the one or more historical case data objects identified by the historical case cohort 413. In various embodiments, system computing entity 106 and/or client computing entity 108 may comprise means, such as processing elements 205, 208, memories 210, 215, 222, 224, network interfaces 220, 226, and/or the like, for generating a confidence value. For example, system computing entity 106 and/or client computing entity 108 comprise computer executable instructions for determining and generating a confidence value for storage in memories 210, 215, 222, 224.

Diagram 400 illustrates an example confidence value 416 of 93.4%. The confidence value 416 may configured to describe or indicate a certainty or uncertainty of the recommendation made by the decision recommendation data object 415. In various embodiments, the confidence value 416 is determined based at least in part on an average similarity value across the historical case cohort 413. For example, the example confidence value of 93.4% is determined based at least in part on averaging the similarity values 412 of 0.97, 0.915, 0.95, and 0.902, in the illustrated embodiment. Thus, the confidence value 416 may indicate the recommendation made by the decision recommendation data object 415 is based at least in part on historical decisions made in historical cases corresponding to historical case data objects in a historical case cohort 413, where the historical cases may be, on average, 93.4% similar to the input case.

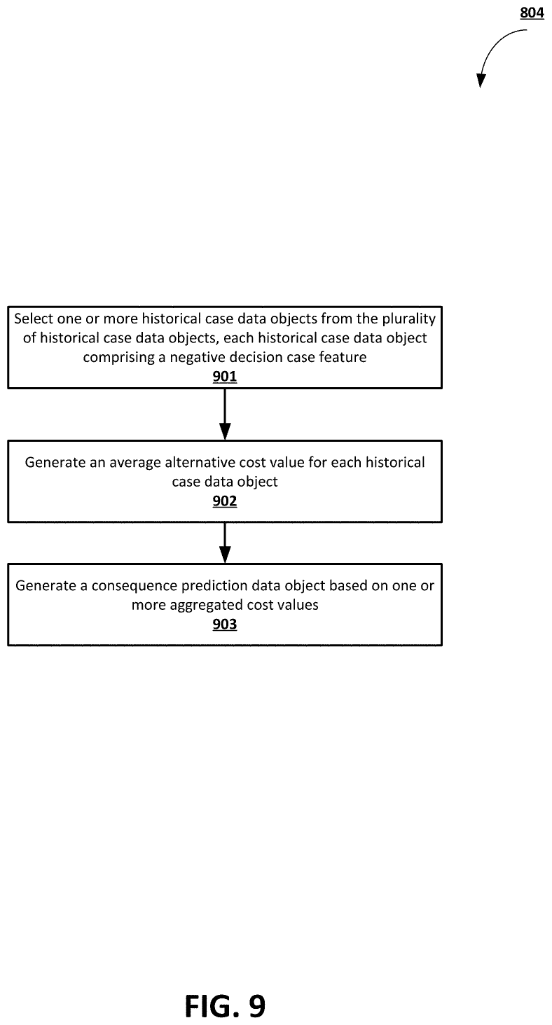

In one embodiment, operation 804 may then follow operation 803. Operation 804 comprises generating a consequence prediction data object. In various embodiments, the consequence prediction data object provides an analysis of potential consequences that may result when a particular decision is made for the input case. For example, the consequence prediction data object provides an analysis of potential consequences that may result when the input prior authorization case is denied. An example consequence prediction data object 417 is illustrated in diagram 400. Operation 804 may be embodied by the example process illustrated in FIG. 9. Specifically, FIG. 9 provides an example embodiment of generating a consequence prediction data object 417 that provides an analysis of potential consequences that may result when a negative decision is made for the input case. For example, the consequence prediction data object 417 may describe an average cost of alternative treatments or step therapy subsequent to a denial of a requested procedure. However, it may be appreciated that a consequence prediction data object 417 may also provide an analysis of potential consequences that may result from positive decisions.

The example process illustrated in FIG. 9 begins at operation 901. Operation 901 comprises selecting one or more historical case data objects from the plurality of historical case data objects, each historical case data objects comprising a negative decision case feature. In doing so, for example, historical prior authorization cases that were denied are selected. In various embodiments, system computing entity 106 and/or client computing entity 108 may comprise means, such as processing elements 205, 208, memories 210, 215, 222, 224, network interfaces 220, 226, and/or the like, for selecting one or more historical case data objects from the plurality of historical case data objects. For example, system computing entity 106 and/or client computing entity 108 access a database 104 (e.g., a graph database, a graphically-structured database, a historical case database) via network interfaces 220, 226 to select one or more historical case data objects.

As aforementioned, the graph-based data structure 406 comprises a plurality of nodes 602 and contains historical case features of the plurality of historical case data objects. Again, each node 602 corresponds to a case feature dimension, and one node 602 may specifically correspond to a decision case feature dimension, thereby storing decision case features from the plurality of historical case data objects. Therefore, selecting one or more historical case data objects that comprise a negative decision case feature may comprise accessing and/or traversing to a node 602 corresponding to a decision case feature dimension and identifying one or more historical case data objects comprising negative decision case features.

In one embodiment, operation 902 may then follow operation 901. Operation 902 comprises generating an average alternative cost value for each historical case data object. In various embodiments, system computing entity 106 and/or client computing entity 108 may comprise means, such as processing elements 205, 208, memories 210, 215, 222, 224, network interfaces 220, 226, and/or the like, for generating an average alternative cost value for each historical case data object. For example, system computing entity 106 generates an average alternative cost value for a historical case data object for storage in memories 210, 215.

In various embodiments, an average alternative cost value is configured to describe costs or consequences resulting from a negative decision being made for a corresponding historical case. For example, denial of a prior authorization case may result in the patient seeking alternative treatment or medicine and/or pursuing step therapy. Those of skill in the art may understand step therapy as being a healthcare approach of providing less expensive and less risk- inducing treatments or medicines as an alternative a treatment or medicine requested in an input prior authorization case. Step therapy may entail beginning with a particular treatment or medicine, and based at least in part on patient response, progressing to more expensive and/or more risk-inducing treatments or medicines in a “step-wise” manner. Thus, it may be understood that, in various embodiments, an average alternative cost value describes the cost of pursuing step therapy for a time period after the corresponding historical prior authorization case was denied.

In various embodiments, an average alternative cost value is specifically generated based at least in part on traversing the graph-based data structure 406. An average alternative cost value may be generated by, subsequent to accessing a node 602 corresponding to a decision case feature dimension and identifying one or more historical case data objects comprising negative decision case features, traversing the graph-based data structure 406 to a node 602 corresponding to an average alternative cost value case feature dimension, and extracting or retrieving an average alternative cost value for a historical case data object comprising a negative decision case feature. In various other embodiments, average alternative cost values are generated based at least in part on traversing the graph-based data structure 406 to one or more nodes 602D corresponding to a claim case feature dimension. For example, a node 602D corresponding to a claim case feature dimension may comprise one or more claim case features describing one or more medical insurance claims made in relation to the historical prior authorization case. In various embodiments, more than one medical insurance claim is made by the patient in relation to the historical prior authorization case (and specifically in relation to the same diagnosis/diagnosis code for which the historical prior authorization case was requested), and more than one node 602 may store a claim case feature describing one medical insurance claim. That is, multiple nodes 602D of the graph-based data structure 406 may be configured to describe a claim history of a patient of a historical prior authorization case. In various embodiments, a claim case feature describing a medical insurance claim may comprise at least a diagnosis code (e.g., an ICD code), a procedure code (e.g., CPT code), and/or a billed cost. Then, an average alternative cost value for a historical case data object may be generated by traversing one or more nodes 602 D corresponding to a claim case feature dimension, and the average alternative cost value may be based at least in part on a summation of the billed costs of the claim case features in the traversed one or more nodes 602. In various embodiments, average alternative cost values are based at least in part on a summation of billed costs of only claim case features comprising the same diagnosis code (e.g., ICD code) as a diagnosis code of the historical case data object. In various embodiments, only billed costs of claims within a pre-determined and/or configured time period are summed. For example, an average alternative cost value is based at least in part on a summation of step therapy costs within 6 months of the date of the historical case. In various embodiments, one or more average alternative cost values for one or more historical case data objects are generated at substantially the same time by traversing the graph-based data structure 406.

In one embodiment, operation 903 may then follow operation 902. Operation 903 comprises generating a consequence prediction data object 417 based at least in part on the one or more average alternative cost values. In various embodiments, system computing entity 106 and/or client computing entity 108 may comprise means, such as processing elements 205, 208, memories 210, 215, 222, 224, network interfaces 220, 226, and/or the like, for generating a consequence prediction data object 417 based at least in part on the one or more average alternative cost values. For example, system computing entity 106 generates a consequence prediction data object 417 for storage in memories 210, 215. In various embodiments, the consequence prediction data object 417 is, comprises, and/or is based at least in part on an average alternative cost value. In the illustrated embodiment of diagram 400, for example, the consequence prediction data object 417 indicates the average cost of step therapy in a plurality of denied historical cases is $1,923 for each individual over a period of 6 months (and thus, a total of $150,000 was spent on denied historical cases). In various embodiments, the consequence prediction data object 417 may also indicate whether the average alternative cost value is greater than or equal to the cost of the requested procedure in the historical case. For example, a requested procedure in the historical may have been denied due to the requested procedure being expensive; however, the average alternative cost value may have been greater than or equal to the cost of the request procedure, possibly suggesting that denying the requested procedure was erroneous.

In various embodiments, a decision rationale data object 418 is further generated. Diagram 400 illustrates a decision rationale data object 418 listing three rationales for negative decisions made for historical cases. The illustrated example decision rationale data object 418 first lists “Not a covered benefit” as the most common rationale, and also indicates that four historical prior authorization cases were denied because the requested treatment or medication was not covered by the patient's coverage plan. Next, decision rationale data object 418 lists “Health Plan Decision” as the rationale for denying two other historical prior authorization cases. Lastly, decision rationale data object 418 lists “Services provided are not for treating sickness” as the rationale for denying one other historical prior authorization case. Decision rationale data object 418 thereby provides additional information and context in recommending a decision for the input case.

In various embodiments, decision rationale data object 418 is generated in a similar manner as the consequence prediction data object 417. For example, a node 602 of the graph-based data structure 406 corresponding to a decision case feature dimension is first accessed or traversed to, in order to identify historical cases that were denied. Next, a node 602 storing data for denial reasons may be traversed to, and the data stored within the node 602 may be processed such that the rationales occurring with the most frequency are identified and extracted. In various embodiments, the graph-based data structure 406 may not have a node 602 specifically related to denial reasons, and system computing entity 106 and/or client computing entity 108 are configured to classify denied historical cases with pre-determined or configured rationales. For example, system computing entity 106 and/or client computing entity 108 are configured to classify denied historical cases with the rationale “Not a covered benefit” based at least in part on traversing the graph-based data structure 406 and obtaining information on patient coverage plans, claims, requested treatments or medications, and/or the like.

Returning to FIG. 8, in one embodiment, operation 805 may follow operation 804. Operation 805 comprises generating a recommendation data object 414 comprising the decision recommendation data object 415, the confidence value 416, and the consequence prediction data object 417. In various embodiments, the recommendation data object 414 further comprises various data objects, such as the decision rationale data object 418. In various embodiments, system computing entity 106 and/or client computing entity 108 may comprise means, such as processing elements 205, 208, memories 210, 215, 222, 224, network interfaces 220, 226, and/or the like, for generating a recommendation data object 414. For example, system computing entity 106 generates a recommendation data object 414 for storage in memories 210, 215. For example, client computing entity 108 generates a recommendation data object 414 in database 104 via network interface 226.

The recommendation data object 414 may be an aggregation, concatenation, and/or the like of at least the decision recommendation data object 415, the confidence value 416, and the consequence prediction data object 417. In an example embodiment, the recommendation data object 414 is a data structure referencing, linking, and/or the like, the decision recommendation data object 415, the confidence value 416, and the consequence prediction data object 417.

Thus, as aforementioned, the example process provided by FIG. 8 may be an example embodiment of operation 306 of providing a recommendation data object 414 for the input case data object 402 based at least in part on the historical case cohort 413. In various embodiments, the recommendation data object 414 is further provided to a user of a client computing entity 108, such as via a user interface 28. In various embodiments, the recommendation data object 414 is generated by a client computing entity 108 and provided to a system computing entity 106.

Returning to FIG. 3, in one embodiment, operation 306—and/or the example embodiment of operation 306 provided by FIG. 8—may be followed by performing automated actions. In various embodiments, system computing entity 106 and/or client computing entity 108 may comprise means, such as processing elements 205, 208, memories 210, 215, 222, 224, network interfaces 220, 226, and/or the like, for performing various actions. Such actions may recommendation-based or decision-based actions. For example, based at least in part on a recommendation for a negative decision, additional information relating to the input case may be retrieved (e.g., from a database 104 ). As another example, a payment may be caused or made based at least in part on a recommendation for a positive decision. As yet another example, a notification indicating a decision or a decision recommendation may be transmitted to another computing entity associated with a patient of the input case. As yet another example, an automated action may be based at least in part on the consequence prediction data object, which may indicate that a cost of alternative treatments is greater than a requested procedure in historical cases, and the automated action may comprise remedying or updating a system used to authorize such historical cases.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method for recommending a decision for an input case, the computer-implemented method comprising:
receiving, by a processor, an input case data object comprising one or more input case features describing the input case;
generating, by the processor, an input feature data object based at least in part on the one or more input case features;
selecting, by the processor, a subgraph-based data structure from a graph-based data structure associated with a plurality of historical case data objects, wherein the subgraph-based data structure identifies a subset of historical case data objects of the plurality of historical case data objects, wherein: (i) each historical case data object is associated with a historical point in time prior to a point in time associated with the input case data object, (ii) each historical case data object comprises a plurality of historical case features including a decision case feature, and (iii) each historical case data object comprises a first historical case feature substantially the same as a first input case feature in a first case feature dimension and a second historical case feature substantially the same as a second input case feature in a second case feature dimension;
generating a feature data model based at least in part on performing one or more graph traversal operations on the subgraph-based data structure;
for each of the subset of historical case data objects, generating, by the processor, a historical feature data object comprising one or more historical case features of the corresponding historical case data object based at least in part on the feature data model;
selecting, by the processor, a historical case cohort identifying one or more historical case data objects of the subset of historical case data objects based at least in part on comparing each historical feature data object to the input feature data object; and
generating, by the processor, a recommendation data object for the input case data object based at least in part on the historical case cohort.

2. The method of claim 1, further comprising:
dynamically selecting an additional subgraph-based data structure responsive to receiving an additional input case data object comprising one or more input case features describing an additional input case, wherein the additional subgraph-based data structure corresponds to the additional input case data object and the additional input case.

3. The computer-implemented method of claim 1, wherein:
the first case feature dimension is a diagnosis case feature dimension, and the first historical case feature comprises at least one diagnosis code identical to a diagnosis code of the first input case feature; and
the second case feature dimension is a procedure case feature dimension, and the second historical case feature comprises at least one procedure code identical to a procedure code of the second input case feature.

4. The computer-implemented method of claim 1, wherein selecting a historical case cohort comprises:
generating a plurality of similarity values, wherein each similarity value corresponds to a historical case data object and is based at least in part on a comparison between a corresponding historical feature data object and the input feature data object;
assigning the plurality of similarity values to each of the subset of historical case data objects; and
generating a historical case cohort identifying one or more historical case data objects based at least in part on the plurality of similarity values.

5. The computer-implemented method of claim 4, wherein a similarity value for a historical case data object is determined based at least in part on a cosine similarity between a corresponding historical feature data object and the input case data object.

6. The computer-implemented method of claim 4, wherein the historical case cohort identifies one or more historical case data objects, each historical case data object assigned with a similarity value greater than or equal to a threshold similarity score.

7. The computer-implemented method of claim 4, wherein the historical case cohort identifies a configurable number of historical case data objects based at least in part on a ranking of the plurality of historical case data objects with respect to each assigned similarity score.

8. The computer-implemented method of claim 1, wherein the recommendation data object comprises at least one of (i) a decision recommendation data object, (ii) a confidence value, or (iii) a consequence prediction data object.

9. The computer-implemented method of claim 8, wherein the decision recommendation data object is generated based at least in part on one or more decision case features in the historical case cohort.

10. The computer-implemented method of claim 8, wherein the confidence value is determined based at least in part on one or more similarity values of the historical case cohort.

11. The computer-implemented method of claim 8, wherein the consequence prediction data object is generated based at least in part on:
selecting one or more historical case data objects from the plurality of historical case data objects, each historical case data object comprising a negative decision case feature;
generating an average alternative cost value for each selected historical case data object; and
generating a consequence prediction data object based at least in part on one or more average alternative cost values.

12. The computer-implemented method of claim 11, wherein the average alternative cost value for each selected historical case data object is generated by performing one or more graph traversal operations on the graph-based data structure.

13. The computer-implemented method of claim 1, wherein generating the input feature data object comprises selecting one or more input case features corresponding to one or more pre-determined or configured case feature dimensions.

14. An apparatus comprising at least one processor and at least one memory comprising computer program code, the at least one memory and the computer program code configured to, with the at least one processor, cause the apparatus to:
receive an input case data object comprising one or more input case features describing the input case;
generate an input feature data object based at least in part on the one or more input case features;
select a subgraph-based data structure from a graph-based data structure associated with a plurality of historical case data objects, wherein the subgraph-based data structure identifies a subset of historical case data objects of the plurality of historical case data objects, wherein: (i) each historical case data object is associated with a historical point in time prior to a point in time associated with the input case data object, (ii) each historical case data object comprises a plurality of historical case features, wherein the plurality of historical case features comprises a decision case feature, and (iii) each historical case data object comprises a first historical case feature substantially the same as a first input case feature in a first case feature dimension and a second historical case feature substantially the same as a second input case feature in a second case feature dimension;
generate a feature data model based at least in part on performing one or more graph traversal operations on the subgraph-based data structure
for each of the subset of historical case data objects, generate a historical feature data object comprising one or more historical case features of the corresponding historical case data object based at least in part on the feature data model;
select a historical case cohort identifying one or more historical case data objects of the subset of historical case data objects based at least in part on comparing each historical feature data object to the input feature data object; and
generate a recommendation data object for the input case data object based at least in part on the historical case cohort.

15. The apparatus of claim 14, wherein the at least one memory and the computer program code are further configured to cause the apparatus to dynamically select an additional subgraph-based data structure responsive to receiving an additional input case data object comprising one or more input case features describing an additional input case, wherein the additional subgraph-based data structure corresponds to the additional input case data object and the additional input case.

16. The apparatus of claim 14, wherein selecting a historical case cohort comprises:
generating a plurality of similarity values, wherein each similarity value corresponds to a historical case data object and is based at least in part on a comparison between a corresponding historical feature data object and the input feature data object;
assigning the plurality of similarity values to each of the subset of historical case data objects; and
generating a historical case cohort identifying one or more historical case data objects based at least in part on the plurality of similarity values.

17. The apparatus of claim 16, wherein a similarity value for a historical case data object is determined based at least in part on a cosine similarity between a corresponding historical feature data object and the input case data object.

18. The apparatus of claim 14, wherein the recommendation data object comprises at least one of (i) a decision recommendation data object, (ii) a confidence value, or (iii) a consequence prediction data object.

19. The apparatus of claim 14, wherein the historical case cohort identifies a configurable number of historical case data objects based at least in part on a ranking of the plurality of historical case data objects with respect to each assigned similarity score.

20. A computer program product comprising at least one computer-readable storage medium having computer-readable program code portions stored therein, the computer-readable program code portions comprising executable portions configured to cause at least one processor to:
receive an input case data object comprising one or more input case features describing the input case;
generate an input feature data object based at least in part on the one or more input case features;
select a subgraph-based data structure from a graph-based data structure associated with a plurality of historical case data objects, wherein the subgraph-based data structure identifies a subset of historical case data objects of the plurality of historical case data objects, wherein: (i) each historical case data object is associated with a historical point in time prior to a point in time associated with the input case data object, (ii) each historical case data object comprises a plurality of historical case features, wherein the plurality of historical case features comprises a decision case feature, and (iii) each historical case data object comprises a first historical case feature substantially the same as a first input case feature in a first case feature dimension and a second historical case feature substantially the same as a second input case feature in a second case feature dimension;
generate a feature data model based at least in part on performing one or more graph traversal operations on the subgraph-based data structure;
for each of the subset of historical case data objects, generate a historical feature data object comprising one or more historical case features of the corresponding historical case data object based at least in part on the feature data model;
select a historical case cohort identifying one or more historical case data objects of the subset of historical case data objects based at least in part on comparing a plurality of historical feature data objects to the input feature data object; and
generate a recommendation data object for the input case data object based at least in part on the historical case cohort.
